(19) United States
(12) Patent Application Publication
(10) Pub. No.: US 2014/0160374 A1
(43) Pub. Date: Jun. 12, 2014

(54) CAPACITIVE TOUCH PANEL AND METHOD OF MAKING THE SAME

(71) Applicant: WINTEK CORPORATION, Taichung City (TW)

(72) Inventors: Wen-Chun Wang, Taichung City (TW); Ching-Fu Hsu, Taichung City (TW); Ting-Yu Chang, Kaohsiung City (TW); Chong-Wei Li, Changhua County (TW); Kuo-Chang Su, Taichung City (TW)

(73) Assignee: WINTEK CORPORATION, Taichung City (TW)

(21) Appl. No.: 14/098,556

(22) Filed: Dec. 6, 2013

(30) Foreign Application Priority Data
Dec. 7, 2012 (TW) 101146213

(51) Int. Cl. G06F 1/16

(52) U.S. Cl. CPC G06F 1/1692
USPC 349/12; 427/79

(57) ABSTRACT

A capacitive touch panel includes a first conductive layer, a second conductive layer and an insulating layer. The first conductive layer includes a plurality of first sensing electrodes, first bridge electrodes and second sensing electrodes. Each of the first sending electrodes and each of the second sending electrodes include a meshed electrode, which has a plurality of openings. The second conductive layer includes a plurality of second bridge electrodes, and each second bridge electrode is electrically connected to two adjacent second sensing electrodes. The insulating layer is disposed between the first conductive layer and the second conductive layer to electrically insulating the first conductive layer from the second conductive layer.

### BACKGROUND OF THE INVENTION

1. Field of the Invention

The present disclosure relates to a capacitive touch panel and a method of fabricating the same, and more particularly, to the capacitive touch panel with meshed sensing electrodes and the method of fabricating the same.

2. Description of the Prior Art

Because of the intelligent characteristics of human-computer interaction, touch panels have been widely applied to the external input interfaces of many electronic products. In addition, the capacitive touch panels have become a mainstream technology in the mid-to-high-end consumer electronics among current techniques owing to its outstanding features, such as high accuracy, multi-touch property, better endurance and high touch resolution.

In recent years, as the applications of electronic products have developed diversely, consumer electronics with the integration of touch sensing functions and display panels are commercialized a lot and have evolved flourishingly, for example, smart phones, tablet PCs and laptop PCs. A capacitive touch display panel integrates a capacitive touch panel with a display panel. In this way, the capacitive touch panel performs touch sensing function, and the display panel displays images at the same time. To ensure the display quality of the display panel, the sensing electrodes of the conventional capacitive touch panels are generally composed of transparent materials, such as indium tin oxide (ITO). However, since the electrical impedance of transparent electrodes is higher than that of metallic electrodes, both the response speed and the accuracy of the capacitive touch panels become inferior to expectation.

### SUMMARY OF THE INVENTION

It is one of the objectives of the disclosure to provide a capacitive touch panel with low impedance and a method of fabricating the same.

A capacitive touch panel is provided in an embodiment of the present invention. The capacitive touch panel includes a substrate, a first conductive layer, a second conductive layer and an insulation layer. The first conductive layer is disposed on the substrate. The first conductive layer includes a plurality of first axis electrodes and a plurality of second axis electrodes. The first axis electrodes extend along a first direction. Each of the first axis electrodes includes a plurality of first sensing electrodes disposed along the first direction, and a plurality of first bridge electrodes electrically connected to two of the first sensing electrodes adjacent to each other respectively. Each of the first sensing electrodes includes a meshed electrode, and the meshed electrode has a plurality of first openings. The second axis electrodes extend along a second direction. Each of the second axis electrodes includes a plurality of second sensing electrodes. Each of the second sensing electrodes includes a meshed electrode, and the meshed electrode has a plurality of second openings. The second conductive layer is disposed on the substrate. The second conductive layer includes a plurality of second bridge electrodes. Each of the second bridge electrodes is at least electrically connected to two of the second sensing electrodes adjacent to each other. The insulation layer is disposed between the first conductive layer and the second conductive layer so as to electrically isolate the second bridge electrodes from the first bridge electrodes.

A method of fabricating a capacitive touch panel is provided in another embodiment of the present invention. A substrate is provided. A first conductive layer is formed on the substrate. The first conductive layer includes a plurality of first axis electrodes and a plurality of second axis electrodes. The first axis electrodes extend along a first direction. Each of the first axis electrodes includes a plurality of first sensing electrodes disposed along the first direction, and a plurality of first bridge electrodes electrically connected to two of the first sensing electrodes adjacent to each other respectively. Each of the first sensing electrodes includes a meshed electrode, and the meshed electrode has a plurality of first openings. The second axis electrodes extend along a second direction. Each of the second axis electrodes includes a plurality of second sensing electrodes. Each of the second sensing electrodes includes a meshed electrode, and the meshed electrode has a plurality of second openings. The second conductive layer is formed on the substrate. The second conductive layer includes a plurality of second bridge electrodes. Each of the second bridge electrodes is at least electrically connected to two of the second sensing electrodes adjacent to each other. The insulation layer is formed on the substrate so as to electrically isolate the second bridge electrodes from the first bridge electrodes.

A capacitive touch panel is provided in another embodiment of the present invention. The capacitive touch panel includes a substrate and a first conductive layer disposed on the substrate. The first conductive layer includes a plurality of first sensing electrodes and a plurality of second sensing electrodes. Each of the first sensing electrodes includes a meshed electrode, and the meshed electrode has a plurality of first openings. Each of the second sensing electrodes includes a meshed electrode, and the meshed electrode has a plurality of second openings. The first sensing electrodes and the second sensing electrodes are not electrically conducted to each other.

A capacitive touch panel is provided in another embodiment of the present invention. The capacitive touch panel includes a substrate, a first conductive layer disposed on the substrate, a second conductive layer disposed on the substrate and a plurality of insulation patterns disposed on the substrate. The first conductive layer includes a plurality of first sensing electrodes disposed along a first direction, a plurality of first bridge electrodes electrically connected to two of the first sensing electrodes adjacent to each other respectively and a plurality of second sensing electrodes disposed along a second direction. Each of the first sensing electrodes includes a meshed electrode, and the meshed electrode has a plurality of first openings. Each of the second sensing electrodes includes a meshed electrode, and the meshed electrode has a plurality of second openings. The second conductive layer includes a plurality of second bridge electrodes. Each of the second bridge electrodes is electrically connected to two of the second sensing electrodes adjacent to each other. Each of the insulation patterns is interposed between the second bridge electrode and the first sensing electrode corresponding to the second bridge electrode so as to electrically isolate the second bridge electrodes from the first sensing electrodes. The first sensing electrodes, the insulation patterns and the second bridge electrodes partially overlap in a vertical projection direction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-4 are schematic diagrams illustrating a method for fabricating a capacitive touch panel according to a first embodiment of the present invention.

FIG. 5 is a schematic diagram illustrating a capacitive touch panel according to a first variant of the first embodiment of the present invention.

FIG. 6 is a schematic diagram illustrating a capacitive touch panel according to a second variant of the first embodiment of the present invention.

FIGS. 7-8 are schematic diagrams illustrating a capacitive touch panel according to a second embodiment of the present invention.

FIGS. 9-10 are schematic diagrams illustrating a capacitive touch panel according to a third embodiment of the present invention.

FIG. 11 is a schematic diagram illustrating a capacitive touch panel according to a variant of the third embodiment of the present invention.

FIG. 12 is a schematic diagram illustrating a capacitive touch panel according to a fourth embodiment of the present invention.

FIG. 13 is a schematic diagram illustrating a capacitive touch panel according to a variant of the fourth embodiment of the present invention.

FIG. 14 is a schematic diagram illustrating a capacitive touch panel according to a fifth embodiment of the present invention.

FIG. 15 is a schematic diagram illustrating a capacitive touch panel according to a first variant of the fifth embodiment of the present invention.

FIG. 16 is a schematic diagram illustrating a capacitive touch panel according to a second variant of the fifth embodiment of the present invention.

FIGS. 17-18 are schematic diagrams illustrating a capacitive touch panel according to a sixth embodiment of the present invention.

FIG. 19 is a schematic diagram illustrating a capacitive touch panel according to a first variant of the sixth embodiment of the present invention.

FIG. 20 is a schematic diagram illustrating a capacitive touch panel according to a second variant of the sixth embodiment of the present invention.

FIG. 21 is a schematic diagram illustrating a capacitive touch panel according to a third variant of the sixth embodiment of the present invention.

FIG. 22 is schematic diagram illustrating a capacitive touch panel according to a seventh embodiment of the present invention.

FIG. 23 is a schematic diagram illustrating a capacitive touch panel according to a variant of the seventh embodiment of the present invention.

FIG. 24 is a schematic diagram illustrating a capacitive touch panel according to an eighth embodiment of the present invention.

FIG. 25 is a schematic diagram illustrating a capacitive touch panel according to a first variant of the eighth embodiment of the present invention.

FIG. 26 is a schematic diagram illustrating a capacitive touch panel according to a second variant of the eighth embodiment of the present invention.

FIG. 27 is a schematic diagram illustrating a capacitive touch panel according to a ninth embodiment of the present invention.

FIG. 28 is a schematic diagram illustrating a capacitive touch panel according to a tenth embodiment of the present invention.

FIG. 29 is a schematic diagram illustrating a capacitive touch panel according to an eleventh embodiment of the present invention.

FIG. 30 is a schematic diagram illustrating a touch display panel according to a first embodiment of the present invention.

FIG. 31 is a schematic diagram illustrating a touch display panel according to a second embodiment of the present invention.

FIG. 32 is a schematic diagram illustrating a touch display panel according to a third embodiment of the present invention.

FIG. 33 is a schematic diagram illustrating the peripheral structure of a touch panel according to an embodiment of the present invention.

### DETAILED DESCRIPTION

To provide a better understanding of the present invention, features of the embodiments will be made in detail. The embodiments of the present invention are illustrated in the accompanying drawings with numbered elements. In addition, the terms such as “first” and “second” described in the present invention are used to distinguish different components or processes, which do not limit the sequence of the components or processes.

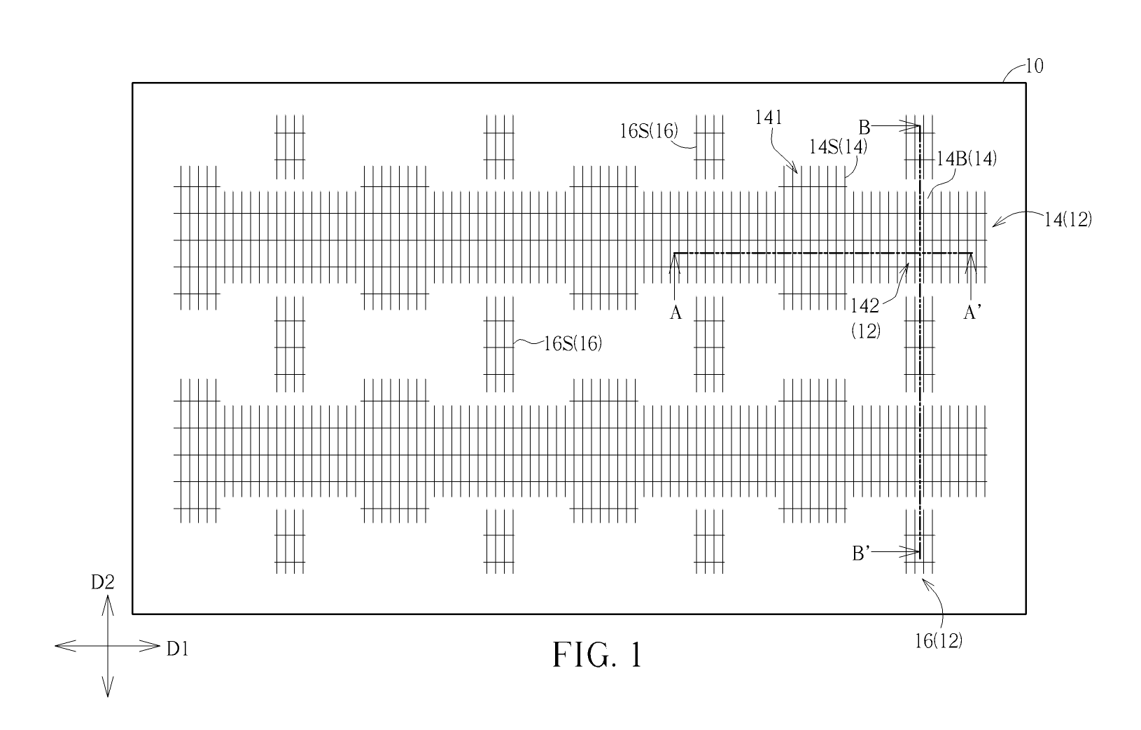

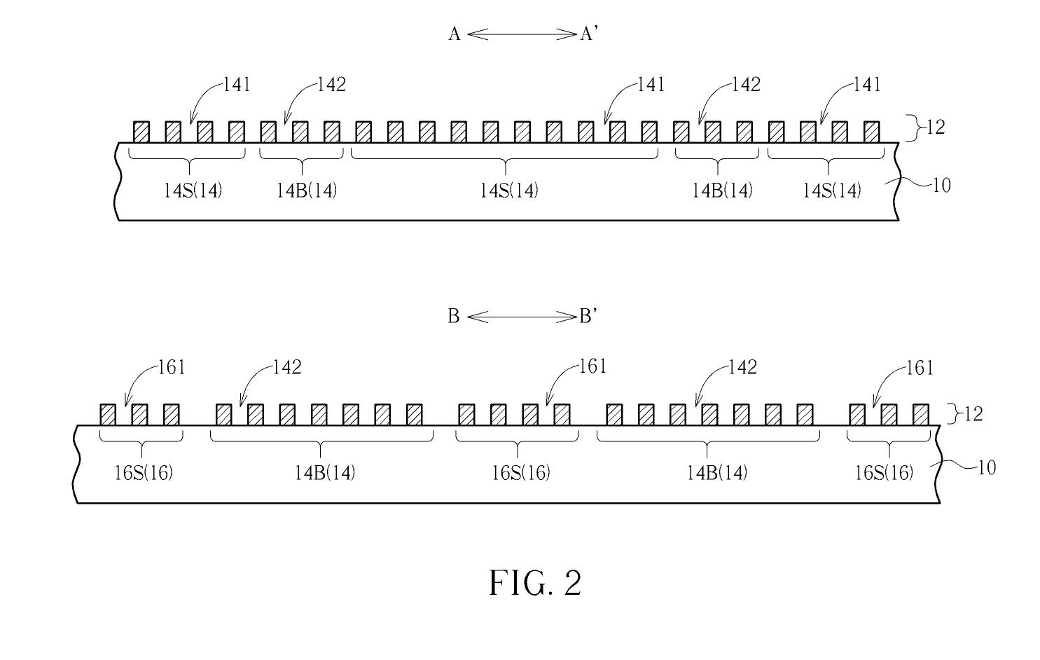

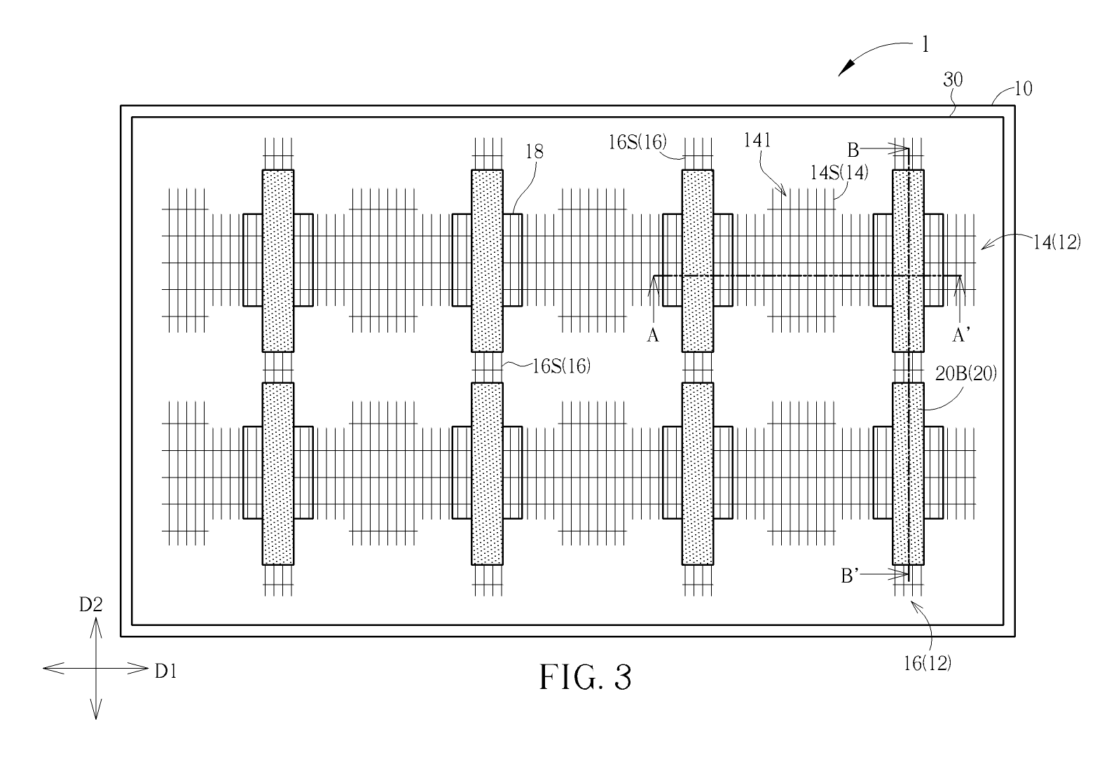

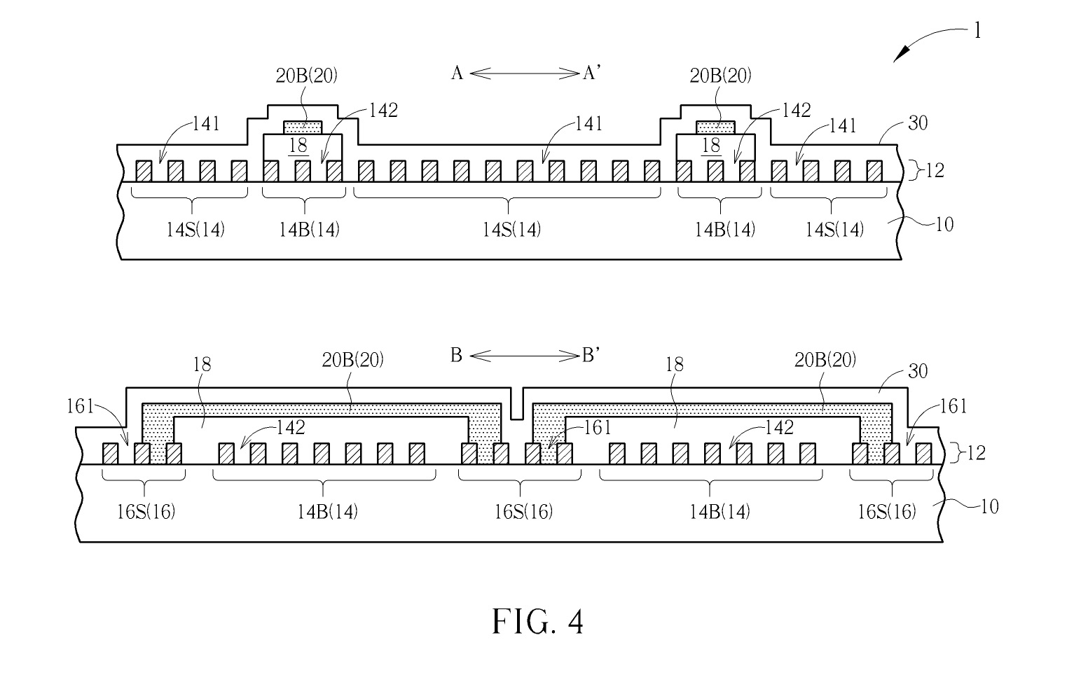

Please refer to FIGS. 1-4. FIGS. 1-4 are schematic diagrams illustrating a method for fabricating a capacitive touch panel according to a first embodiment of the present invention. FIG. 1 and FIG. 3 are schematic diagrams illustrating a top view of the capacitive touch panel according to the first embodiment of the present invention. FIG. 2 is a cross-sectional view diagram taken along cross-sectional lines, A-A′ and B-B′, in FIG. 1. FIG. 4 is a cross-sectional view diagram taken along cross-sectional lines, A-A′ and B-B′, in FIG. 3. As shown in FIGS. 1-2, a substrate 10 is provided first. The substrate is exemplarity embodied as a transparent substrate, such as a glass substrate, a plastic substrate or other kinds of substrates permeable to light and of which the transmittance higher than 85% is still within the scope of the present invention. The transparent substrate may be a transparent cover. The transparent cover may include a glass cover, a plastic cover or other kinds of covers which formed from materials of high mechanical strength to protect (for example, against scratches), cover, or decorate the corresponding devices (such as a display device). The thickness of the transparent cover may be in a range of 0.2 mm to 2 mm. The transparent cover may be in a flat shape, curved shape or the combination thereof, such as a 2.5D or 3D shaped tempered glass; however, the present invention is not limited thereto. Alternatively, an anti-smudge coating may be disposed on a side of the transparent cover for the operation of users. Then, a first conductive layer 12 is formed on the substrate 10. The material of the first conductive layer 12 includes opaque conductive materials, which may be metal, for example but not limited to, at least one of gold (Au), aluminum (Al), copper (Cu), silver (Ag), chromium (Cr), titanium (Ti), molybdenum (Mo), neodymium (Nd), an alloy thereof, a composite layer thereof, and the composite layer of the above-mentioned materials and alloys. However, the opaque conductive materials are not limited to the above-mentioned materials and the opaque conductive materials may also include other conductive materials. Moreover, the above-mentioned composite layers may be three-layer stacked structures, which comprise molybdenum (Mo), Al—Nd alloy (i.e., an alloy of aluminum and neodymium) and molybdenum (Mo) disposed in that order, but the present invention is not limited to this and any stacked structure with the desired conductive properties is within the scope of the present invention. It is worth noting that, generally, opaque conductive materials are not permeable to light; nevertheless, as the thickness is attenuated, the opaque conductive materials may permeable to light or partially permeable to light. The patterns of the first conductive layer 12 can be defined by various types of patterning processes, such as a lithography etching process (i.e., a lithography process and an etching process), but not limited thereto. The first conductive layer 12 includes a plurality of first axis electrodes 14 and a plurality of second axis electrodes 16. The first axis electrodes 14 extend along a first direction D1. The second axis electrodes 16 extend along a second direction D2. Each of the first axis electrodes 14 includes a plurality of first sensing electrodes 14S and a plurality of first bridge electrodes 14B. The first sensing electrodes 14S are disposed along the first direction D1. The first bridge electrodes 14B are electrically connected to two of the first sensing electrodes 14S adjacent to each other respectively. Each of first sensing electrodes 14S includes a meshed electrode, and the meshed electrode has a plurality of first openings 141. Each of the second axis electrodes 16 includes a plurality of second sensing electrodes 16S. Each of the second sensing electrodes 16S includes a meshed electrode, and the meshed electrode has a plurality of second openings 161. Moreover, in this embodiment, each of the first bridge electrodes 14B may also include a meshed electrode, and the meshed electrode has a plurality of third openings 142. In a variant embodiment, each of the first bridge electrodes 14B may be a stripe electrode without an opening. The width of the stripe electrode is preferably narrower than that of the meshed electrode. In this embodiment, the material, the thickness, the shape, the size, and the width of the first sensing electrodes 14S, the second sensing electrodes 16S and the first bridge electrodes 14B, and the shape and the size of the first openings 141 and the second openings 161 may be further modified according to the electrical requirements and the optical requirements. For example, the openings of the first sensing electrodes 14S, the second sensing electrodes 16S and the first bridge electrodes 14B may be rectangular openings, but not limited thereto. It is worth noting that the first conductive layer 12 may further include a plurality of trace lines (not shown). The trace lines are disposed on the periphery of the substrate 10. The trace lines electrically connect the first axis electrodes 14 corresponding to the trace lines and the second axis electrodes 16 corresponding to the trace lines. Furthermore, before the first conductive layer 12 is formed, a decoration pattern (not shown) may have been formed on the periphery of the substrate 10 selectively. The material of the decoration pattern may include at least one of ceramic, diamond-like carbon, ink, photoresist or resin materials. Furthermore, a portion of the first conductive layer 12 can be selectively disposed on the decorative pattern. As shown in FIG. 2, which is the cross-sectional view diagram taken along a cross-sectional line B-B′ in FIG. 1, the second sensing electrodes 16S and the first bridge electrodes 14B are not electrically conducted to each other. In addition, the first axis electrodes 14 and the second axis electrodes 16 can be made of the same conductive material. Alternatively, the first axis electrodes 14 and the second axis electrodes 16 can be made of different conductive materials, for example, the first axis electrodes 14 can be made of one kind of conductive material, and the second axis electrodes 16 can be made of another kind of conductive material different from the conductive material of the first axis electrodes 14. Furthermore, in this present invention, the meshed electrodes have a plurality of conductive lines connected to each other. Each conductive line has a width in the range of 0.1 micrometers (um) to 20 um. Preferably, the width of each conductive line is in the range of 1 um to 10 um.

As shown in FIGS. 3-4, an insulation layer 18 is formed on the substrate 10. The insulation layer 18 may include an organic insulation layer, which may be patterned, for example, by exposure processes and development processes. The insulation layer 18 may include an inorganic insulation layer, which may be patterned, for example, by lithography etching processes, but not limited thereto. In this embodiment, the insulation layer 18 covers the first bridge electrodes 14B and at least partially exposes the second sensing electrodes 16S. The insulation layer 18 may further selectively cover first sensing electrodes 14S. Then, a second conductive layer 20 is formed on the insulation layer 18. The second conductive layer 20 is patterned so as to define its patterns. In this embodiment, the material of the second conductive layer 20 may include transparent conductive materials, inter alia, indium tin oxide (ITO), indium zinc oxide (IZO) or other kinds of transparent conductive materials. The second conductive layer 20 includes a plurality of second bridge electrodes 20B. Each of the second bridge electrodes 20B is at least electrically connected to two of the adjacent second sensing electrodes 16S (the second sensing electrodes 16S adjacent to each other) exposed by the insulation layer 18. At last, a protective layer 30 is formed on the substrate 10. The protective layer 30 covers the first conductive layer 12, the insulation layer 18 and the second conductive layer 20. Accordingly, the capacitive touch panel 1 of this embodiment is accomplished. In this embodiment, the insulation layer 18 is formed after the first conductive layer 12 has been formed, and the second conductive layer 20 is formed after the insulation layer 18 has been formed, but not limited thereto. In addition, the insulation layer 18 is interposed between the first bridge electrodes 14B and the second bridge electrodes 20B so as to electrically isolate the second bridge electrodes 20B from the first bridge electrodes 14B. In other embodiment, the first/second sensing electrodes 14S/16S and the first bridge electrodes 14B can be made of the same conductive material, but the conductive material of the second bridge electrodes 20B can be different from the conductive material of the first bridge electrodes 14B, such that the equivalent impedance seen by second axis electrodes 16 and the second bridge electrodes 20B connected between adjacent second sensing electrodes 16S can be adjusted to meet the requirement of design.

As shown in FIGS. 3-4, in this embodiment, first sensing electrodes 14S and the second sensing electrodes 16S are formed of opaque conductive materials, for example but not limited to, metal. Nevertheless, first sensing electrodes 14S and the second sensing electrodes 16S have the first openings 141 and the second openings 161 respectively. Compared with transparent conductive materials, metallic conductive materials have lower impedance, and thus the capacitive touch panel 1 of this embodiment may have better electrical performance—thereby enhancing touch sensitivity and promoting accuracy. Moreover, first sensing electrodes 14S and the second sensing electrodes 16S are meshed electrodes, and the openings are designed to allow light to pass through. Therefore, with the design of the meshed electrodes, the displayed image of the touch display panel will not be obscured.

The capacitive touch panel and its fabrication method are not restricted to the preceding embodiments in the present invention. Other embodiments or modifications will be detailed in the following description. In order to simplify and show the differences or modifications between the following embodiments and the above-mentioned embodiment, the same numerals denote the same components in the following description, and the similar parts are not detailed redundantly.

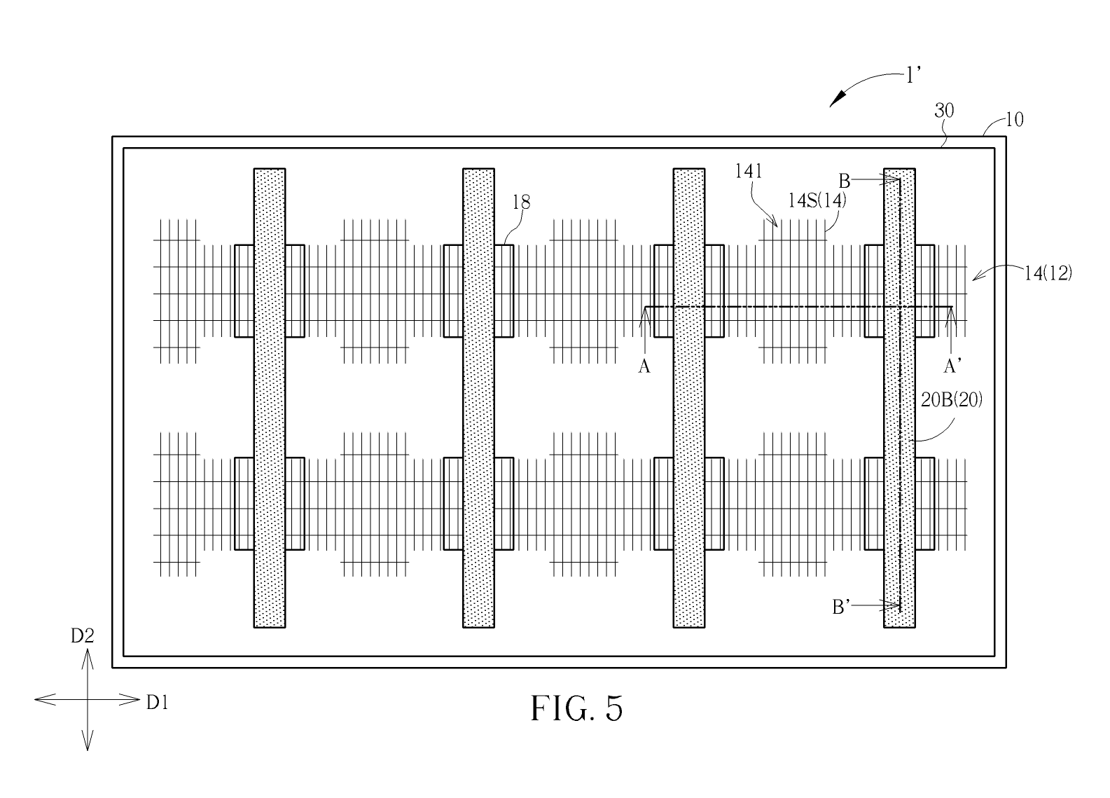

Please refer to FIG. 5. FIG. 5 is a schematic diagram illustrating a capacitive touch panel according to a first variant of the first embodiment of the present invention. As shown in FIG. 5, compared with the first embodiment, in the capacitive touch panel 1′ of the first variant of the first embodiment, each of the second bridge electrodes 20B is electrically connected to all the second sensing electrodes 16S corresponding to the second axis electrode 16.

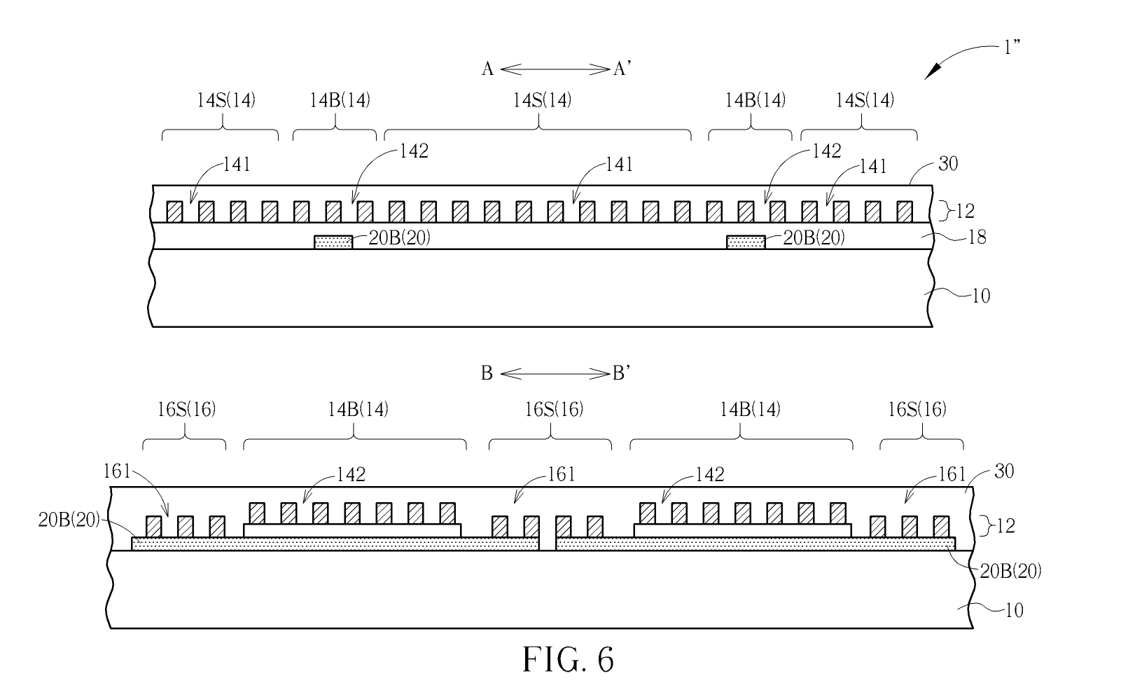

Please refer to FIG. 6, and also refer to FIG. 3. FIG. 6 is a schematic diagram illustrating a capacitive touch panel according to a second variant of the first embodiment of the present invention. As shown in FIG. 6, compared with the first embodiment, in the capacitive touch panel 1″ of the second variant of the first embodiment, the insulation layer 18 is formed after the second conductive layer 20 has been formed, and the first conductive layer 12 is formed after the insulation layer 18 has been formed. In other words, the second conductive layer 20 is disposed between the substrate 10 and the insulation layer 18. The insulation layer 18 is disposed between the second conductive layer 20 and the first conductive layer 12.

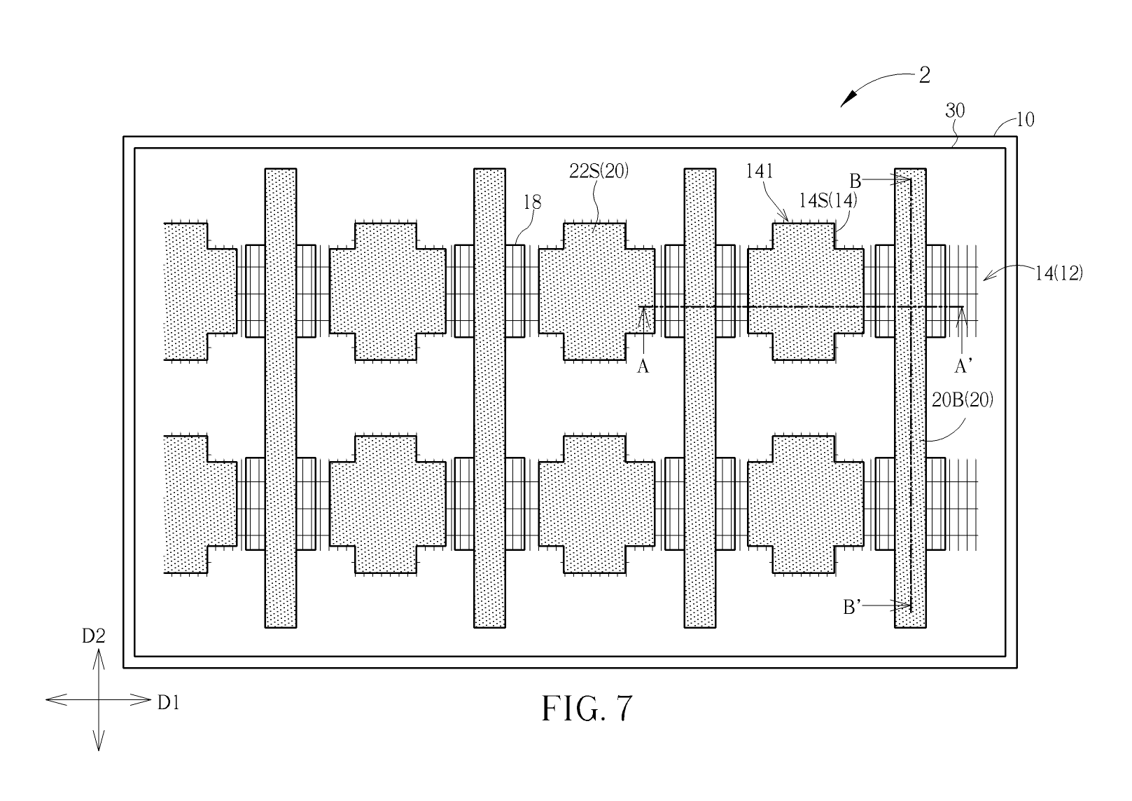

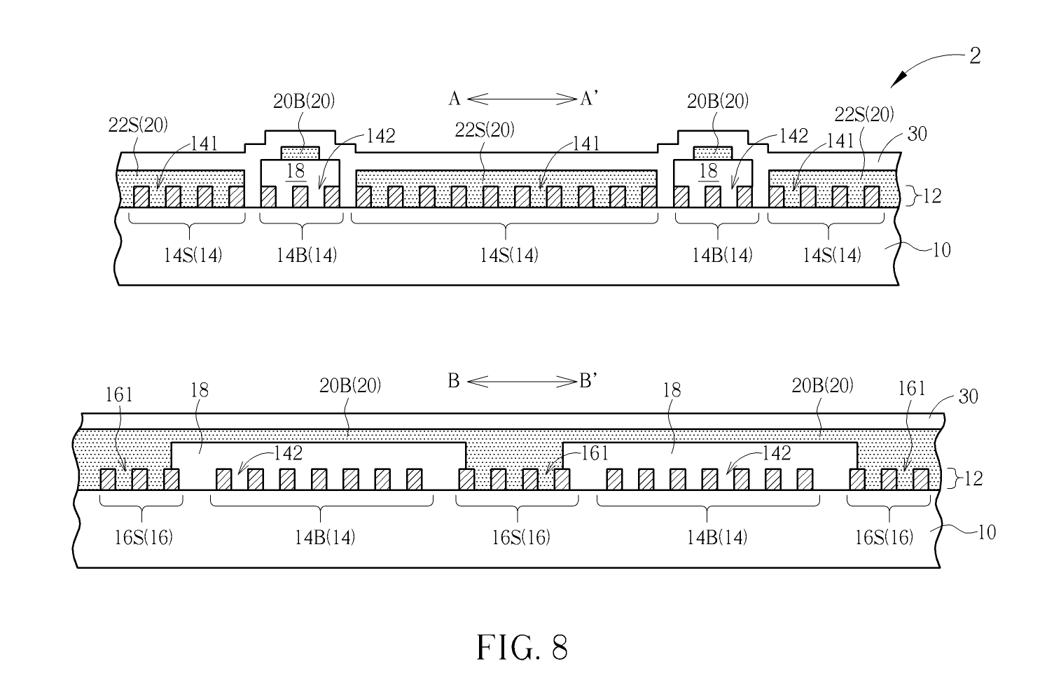

Please refer to FIGS. 7-8. FIGS. 7-8 are schematic diagrams illustrating a capacitive touch panel according to a second embodiment of the present invention. FIG. 7 is a schematic diagram illustrating a top view of the capacitive touch panel according to the second embodiment of the present invention. FIG. 8 is a cross-sectional view diagram taken along cross-sectional lines, A-A′ and B-B′, in FIG. 7. As shown in FIGS. 7-8, the difference between the first embodiment and this embodiment is that, in the capacitive touch panel 2 of this embodiment, the second conductive layer 20 further includes a plurality of third sensing electrodes 22S, and the third sensing electrodes 22S are not electrically conducted to the second bridge electrodes 20B. However, the third sensing electrodes 22S are in contact with and electrically connected to the corresponding first sensing electrodes 14S (the first sensing electrodes 14S corresponding the third sensing electrodes 22S) respectively. In this embodiment, the material of the second conductive layer 20 may include transparent conductive materials, inter alia, indium tin oxide (ITO), indium zinc oxide (IZO) or other kinds of transparent conductive materials. Since the third sensing electrodes 22S are transparent, the displayed image of the touch display panel will not be obscured. Moreover, because the third sensing electrodes 22S and the first sensing electrodes 14S corresponding to the third sensing electrodes 22S are connected completely in parallel, the equivalent impedance can be effectively reduced. In this embodiment, the second bridge electrodes 20B are electrically connected to all the second sensing electrodes 16S corresponding to the second axis electrodes 16, but not limited thereto. For instance, the second bridge electrodes 20B may only be electrically connected to two of the adjacent second sensing electrodes 16S. Furthermore, the insulation layer 18 is formed after the first conductive layer 12 has been formed, and the second conductive layer 20 is formed after the insulation layer 18 has been formed, but not limited thereto. For example, in a variant embodiment, the insulation layer 18 is formed after the second conductive layer 20 has been formed, and the first conductive layer 12 is formed after the insulation layer 18 has been formed.

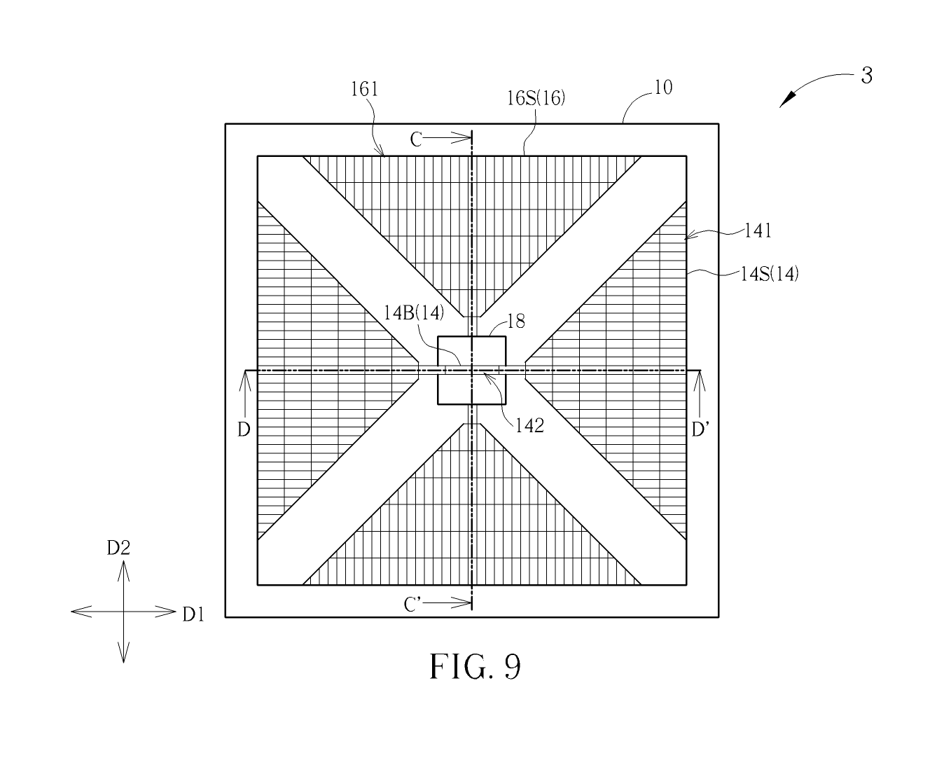

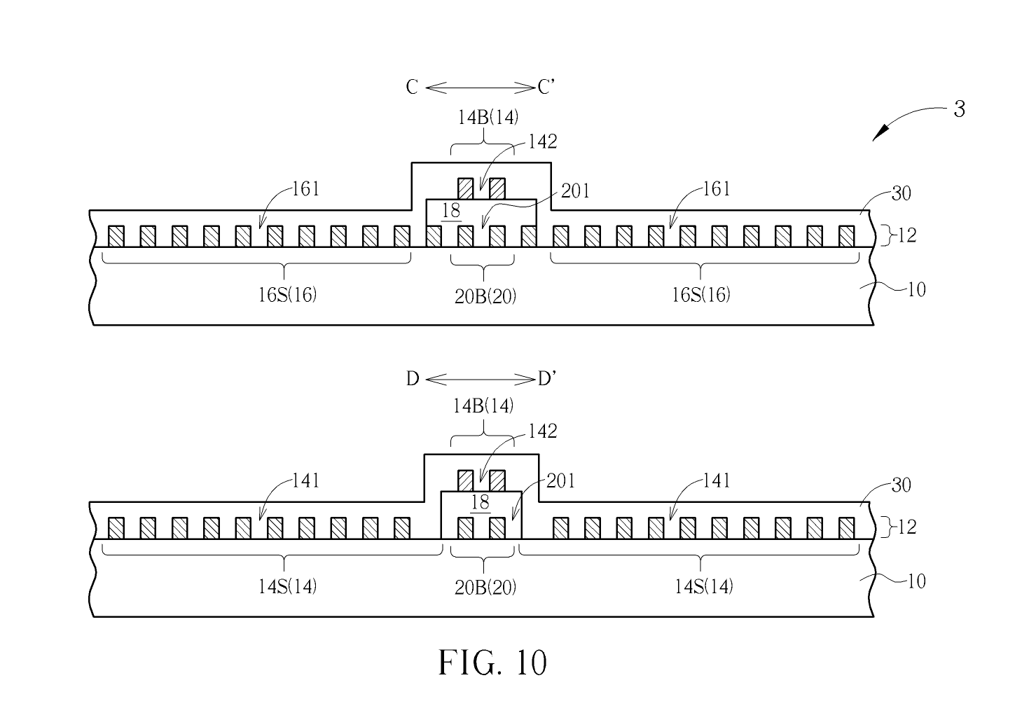

Please refer to FIGS. 9-10. FIGS. 9-10 are schematic diagrams illustrating a capacitive touch panel according to a third embodiment of the present invention. FIG. 9 is a schematic diagram illustrating a top view of the capacitive touch panel according to the third embodiment of the present invention. FIG. 10 is a cross-sectional view diagram taken along cross-sectional lines, C-C′ and D-D′, in FIG. 1. As shown in FIGS. 9-10, the difference between the first embodiment and this embodiment is that, in the capacitive touch panel 3 of this embodiment, the material of the first conductive layer 12 and the second conductive layer 20 includes opaque conductive materials, which may be metal, for example but not limited to, at least one of gold (Au), aluminum (Al), copper (Cu), silver (Ag), chromium (Cr), titanium (Ti), molybdenum (Mo), neodymium (Nd), an alloy thereof, a composite layer thereof, and the composite layer of the above-mentioned materials and alloys. However, the opaque conductive materials are not limited to the above-mentioned materials and the opaque conductive materials may also include other conductive materials. Moreover, the above-mentioned composite layers may be three-layer stacked structures, which comprise molybdenum (Mo), Al—Nd alloy (i.e., an alloy of aluminum and neodymium) and molybdenum (Mo) disposed in that order, but the present invention is not limited to this and any stacked structure with the desired conductive properties is within the scope of the present invention. In addition, each of the second bridge electrodes 20B preferably includes a meshed electrode, and the meshed electrode has a plurality of third openings 201, but not limited thereto. In a variant embodiment, each of the second bridge electrodes 20B may be a stripe electrode without an opening. The width of the stripe electrode is preferably narrower than that of the meshed electrode. In this embodiment, the insulation layer 18 is formed after the second conductive layer 20 has been formed, and the first conductive layer 12 is formed after the insulation layer 18 has been formed. In other words, the second conductive layer 20 is disposed between the substrate 10 and the insulation layer 18. The insulation layer 18 is disposed between the second conductive layer 20 and the first conductive layer 12.

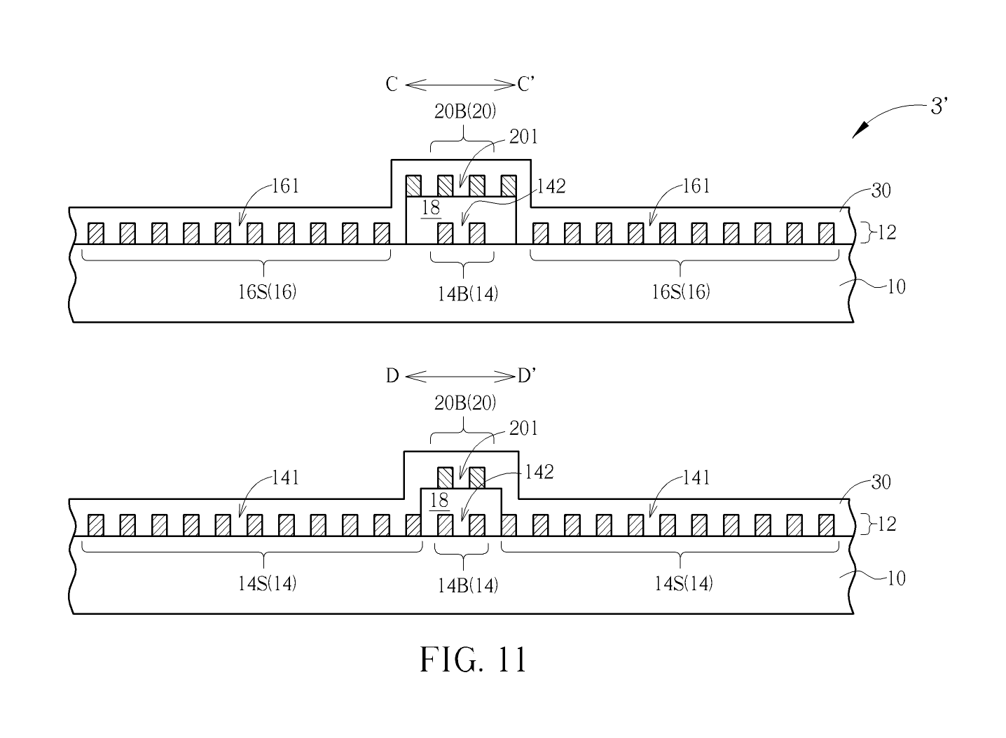

Please refer to FIG. 11, and also refer to FIG. 9. FIG. 11 is a schematic diagram illustrating a capacitive touch panel according to a variant of the third embodiment of the present invention. As shown in FIG. 11, compared with the third embodiment, in the capacitive touch panel 3′ of the second variant of the third embodiment, the insulation layer 18 is formed after the first conductive layer 12 has been formed, and the second conductive layer 20 is formed after the insulation layer 18 has been formed. In other words, the first conductive layer 12 is disposed between the substrate 10 and the insulation layer 18. The insulation layer 18 is disposed between the first conductive layer 12 and the second conductive layer 20.

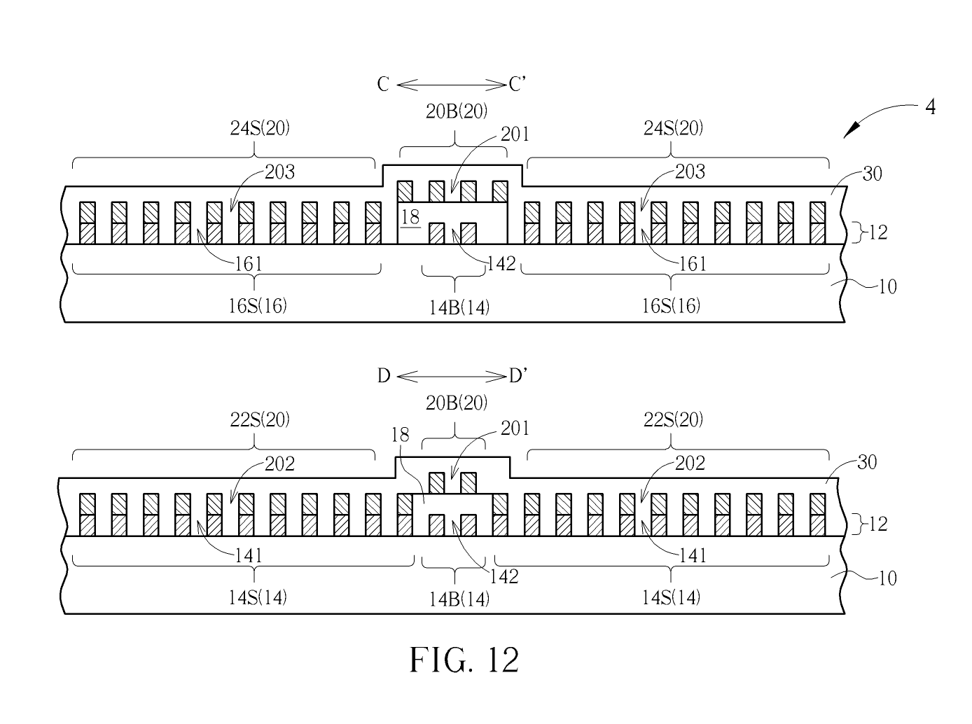

Please refer to FIG. 12. FIG. 12 is a schematic diagram illustrating a capacitive touch panel according to a fourth embodiment of the present invention. As shown in FIG. 12, the difference between the third embodiment and this embodiment is that, in the capacitive touch panel 4 of this embodiment, the second conductive layer 20 further includes a plurality of third sensing electrodes 22S and a plurality of fourth sensing electrodes 24S. The third sensing electrodes 22S are not electrically conducted to the second bridge electrodes 20B. However, the third sensing electrodes 22S are in contact with and electrically connected to the corresponding first sensing electrodes 14S respectively. The fourth sensing electrodes 24S are in contact with and electrically connected to the corresponding second sensing electrodes 16S respectively. More specifically, the fourth sensing electrodes 24S may be directly electrically connected to the second bridge electrodes 20B, or the fourth sensing electrodes 24S may be electrically connected to the second bridge electrodes 20B through the second sensing electrodes 16S. In this embodiment, the material of the first conductive layer 12 and the second conductive layer 20 includes opaque conductive materials, which may be metal, for example but not limited to, at least one of gold (Au), aluminum (Al), copper (Cu), silver (Ag), chromium (Cr), titanium (Ti), molybdenum (Mo), neodymium (Nd), an alloy thereof, a composite layer thereof, and the composite layer of the above-mentioned materials and alloys. However, the opaque conductive materials are not limited to the above-mentioned materials and the opaque conductive materials may also include other conductive materials. Moreover, the above-mentioned composite layers may be three-layer stacked structures, which comprise molybdenum (Mo), Al—Nd alloy (i.e., an alloy of aluminum and neodymium) and molybdenum (Mo) disposed in that order, but the present invention is not limited to this and any stacked structure with the desired conductive properties is within the scope of the present invention. Besides, each of the third sensing electrodes 22S is a meshed electrode, and the meshed electrode has a plurality of fourth openings 202. The fourth openings 202 correspond to the first openings 141 of each of first sensing electrodes 14S. Each of the fourth sensing electrodes 24S includes a meshed electrode, and the meshed electrode has a plurality of fifth openings 203. The fifth openings 203 correspond to the second openings 161 of each of the second sensing electrodes 16S. Because the third sensing electrodes 22S and the first sensing electrodes 14S corresponding to the third sensing electrodes 22S are connected completely in parallel, and because the fourth sensing electrodes 24S and the second sensing electrodes 16S corresponding to the fourth sensing electrodes 24S are connected completely in parallel, the equivalent impedance can be effectively reduced. In this embodiment, the insulation layer 18 is formed after the first conductive layer 12 has been formed, and the second conductive layer 20 is formed after the insulation layer 18 has been formed, but not limited thereto. For example, in a variant embodiment, the insulation layer 18 is formed after the second conductive layer 20 has been formed, and the first conductive layer 12 is formed after the insulation layer 18 has been formed.

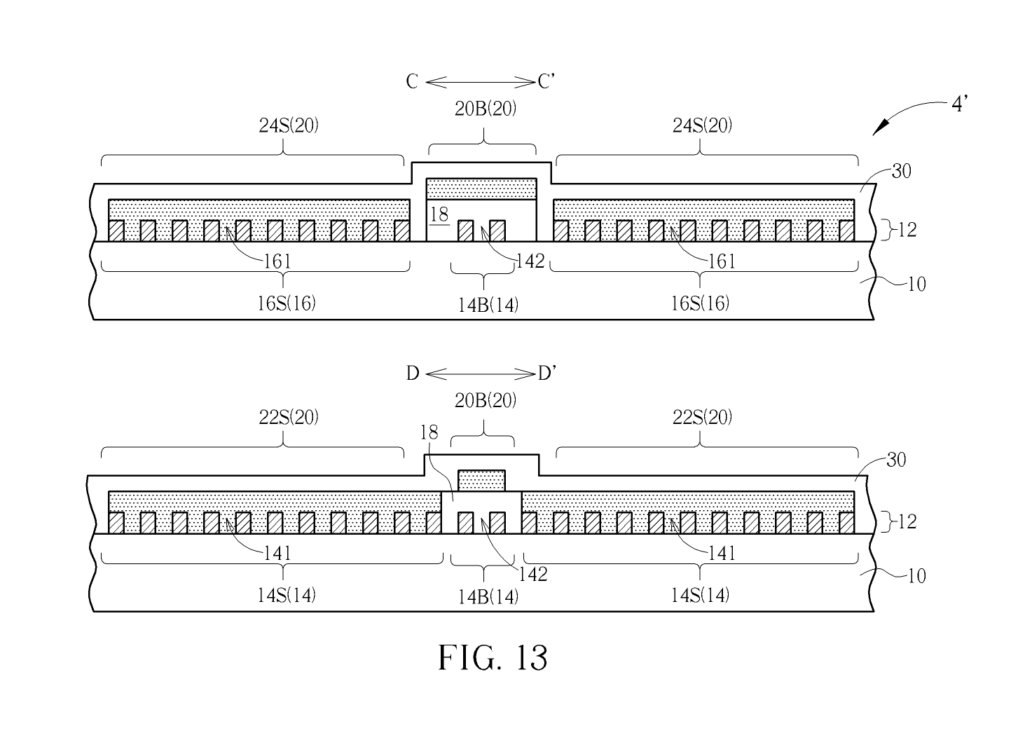

Please refer to FIG. 13. FIG. 13 is a schematic diagram illustrating a capacitive touch panel according to a variant of the fourth embodiment of the present invention. As shown in FIG. 13, the difference between the fourth embodiment and this embodiment is that, in the capacitive touch panel 4′ of this embodiment, the material of the second conductive layer 20 may include transparent conductive materials, inter alia, indium tin oxide (ITO), indium zinc oxide (IZO) or other kinds of transparent conductive materials—in other words, the third sensing electrodes 22S and the fourth sensing electrodes 24S are transparent electrodes. The third sensing electrodes 22S are not electrically conducted to the second bridge electrodes 20B. However, the third sensing electrodes 22S are in contact with and electrically connected to the corresponding first sensing electrodes 14S respectively. The fourth sensing electrodes 24S are in contact with and electrically connected to the corresponding second sensing electrodes 16S respectively. More specifically, the fourth sensing electrodes 24S may be directly electrically connected to the second bridge electrodes 20B, or the fourth sensing electrodes 24S may be electrically connected to the second bridge electrodes 20B through the second sensing electrodes 16S.

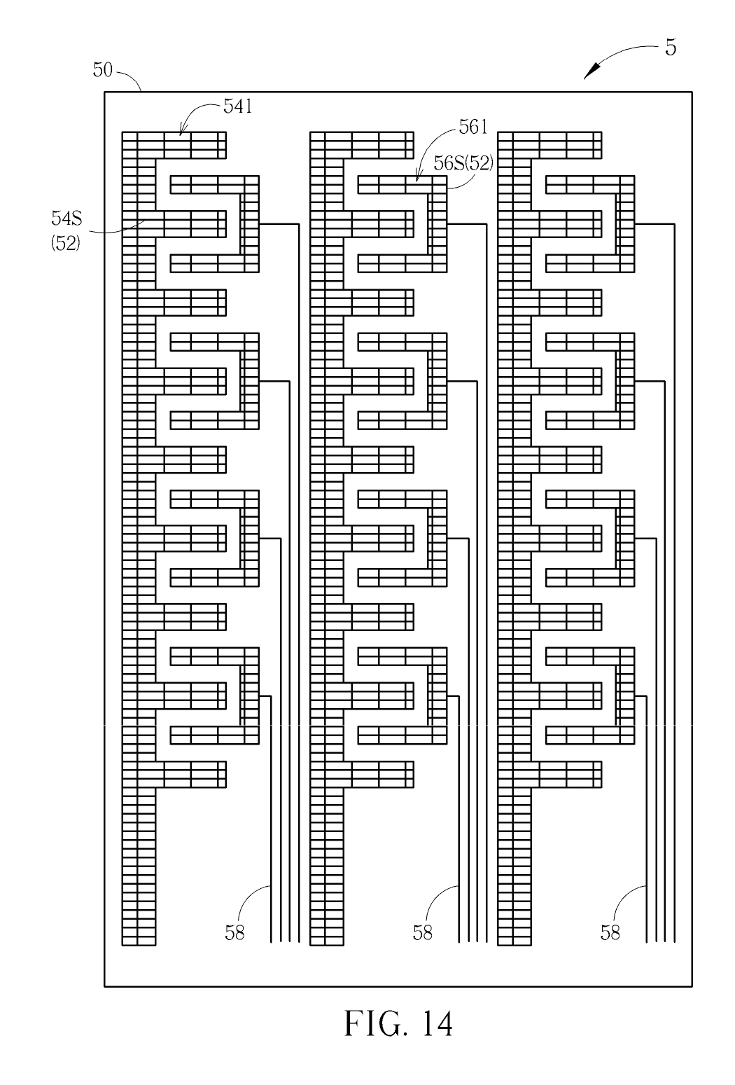

Please refer to FIG. 14. FIG. 14 is a schematic diagram illustrating a capacitive touch panel according to a fifth embodiment of the present invention. As shown in FIG. 14, the capacitive touch panel 5 in this embodiment includes a substrate 50 and a first conductive layer 52 disposed on the substrate 50. The first conductive layer 52 includes a plurality of first sensing electrodes 54 and a plurality of second sensing electrodes 56S. Each of the first sensing electrodes 54S includes a meshed electrode, and the meshed electrode has a plurality of first openings 541. Each of the second sensing electrodes 56S includes a meshed electrode, and the meshed electrode has a plurality of second openings 561. The capacitive touch panel 5 in this embodiment is a mutual-capacitance single-layered sensing touch panel. The first sensing electrodes 54S and the second sensing electrodes 56S are formed from the same conductive layer and are not electrically conducted to each other. Each of the first sensing electrodes 54S and each of the second sensing electrodes 56S are a driving electrode and a receiving electrode respectively. Specifically speaking, in this embodiment, the first sensing electrodes 54S are the driving electrodes and the second sensing electrodes 56S are the receiving electrodes. The material of the first conductive layer 52 includes opaque conductive materials, which may be metal, for example but not limited to, at least one of gold (Au), aluminum (Al), copper (Cu), silver (Ag), chromium (Cr), titanium (Ti), molybdenum (Mo), neodymium (Nd), an alloy thereof, a composite layer thereof, and the composite layer of the above-mentioned materials and alloys. However, the opaque conductive materials are not limited to the above-mentioned materials and the opaque conductive materials may also include other conductive materials. Moreover, the above-mentioned composite layers may be three-layer stacked structures, which comprise molybdenum (Mo), Al—Nd alloy (i.e., an alloy of aluminum and neodymium) and molybdenum (Mo) disposed in that order, but the present invention is not limited to this and any stacked structure with the desired conductive properties is within the scope of the present invention. That is to say, the first sensing electrodes 54S and the second sensing electrodes 56S are formed of opaque conductive materials, such as metal; in the meantime, the first sensing electrodes 54S and the second sensing electrodes 56S have the first openings 541 and the second openings 561 respectively. Compared with transparent conductive materials, metallic conductive materials have lower impedance, and thus the capacitive touch panel 5 of this embodiment may have better electrical performance—thereby enhancing touch sensitivity and promoting accuracy. Moreover, the first sensing electrodes 54S and the second sensing electrodes 56S are meshed electrodes, and the openings are designed to allow light to pass through. Therefore, with the design of the meshed electrodes, the displayed image of the touch display panel will not be obscured. There may also be a plurality of wires 58 in the capacitive touch panel 5. The wires 58 are electrically connected to the corresponding second sensing electrodes 56S respectively. The wires 58 may be also formed from the first conductive layer 52, but not limited thereto.

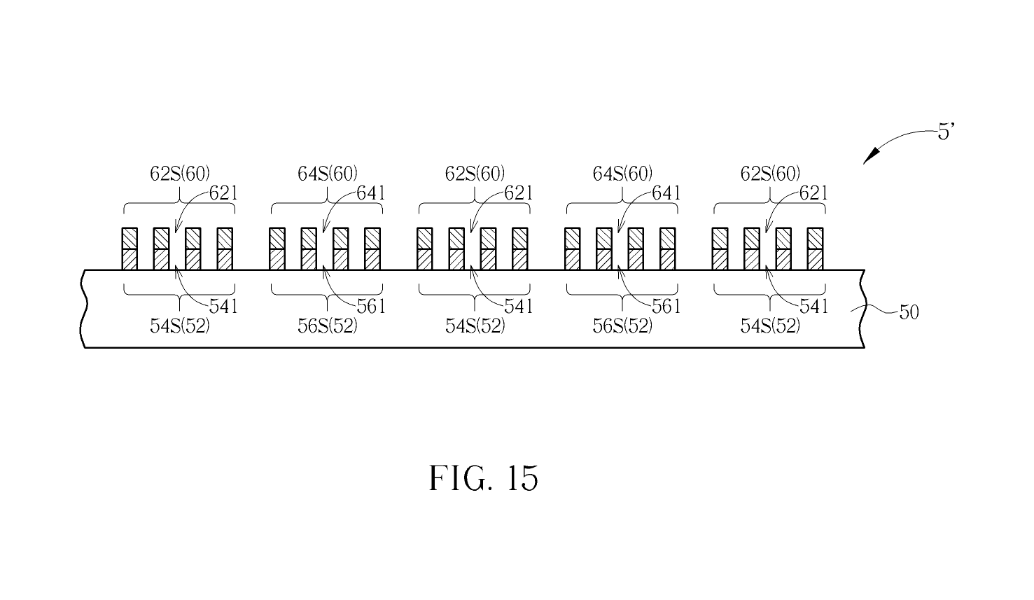

Please refer to FIG. 15. FIG. 15 is a schematic diagram illustrating a capacitive touch panel according to a first variant of the fifth embodiment of the present invention. As shown in FIG. 15, compared with the fifth embodiment, the capacitive touch panel 5′ of the first variant embodiment further includes a second conductive layer 60 disposed on the first conductive layer 52. The second conductive layer 60 includes a plurality of third sensing electrodes 62S and a plurality of fourth sensing electrodes 64S. The third sensing electrodes 62S are disposed on the first sensing electrodes 54S respectively; moreover, the third sensing electrodes 62S are in contact with and electrically connected to the first sensing electrodes 54S respectively. The fourth sensing electrodes 64S are disposed on the second sensing electrodes 56S respectively, and the fourth sensing electrodes 64S are in contact with and electrically connected to the second sensing electrodes 56S respectively. In the first variant embodiment, the material of the first conductive layer 52 and the second conductive layer 60 includes opaque conductive materials, which may be metal, for example but not limited to, at least one of gold (Au), aluminum (Al), copper (Cu), silver (Ag), chromium (Cr), titanium (Ti), molybdenum (Mo), neodymium (Nd), an alloy thereof, a composite layer thereof, and the composite layer of the above-mentioned materials and alloys. However, the opaque conductive materials are not limited to the above-mentioned materials and the opaque conductive materials may also include other conductive materials. Moreover, the above-mentioned composite layers may be three-layer stacked structures, which comprise molybdenum (Mo), Al—Nd alloy (i.e., an alloy of aluminum and neodymium) and molybdenum (Mo) disposed in that order, but the present invention is not limited to this and any stacked structure with the desired conductive properties is within the scope of the present invention. Each of the third sensing electrodes 62S includes a meshed electrode, and the meshed electrode has a plurality of third openings 621. The third openings 621 correspond to the first openings 541 of each of the first sensing electrodes 54S. Each of the fourth sensing electrodes 64S includes a meshed electrode, and the meshed electrode has a plurality of fourth openings 641. The fourth openings 641 correspond to the second openings 561 of each of the second sensing electrodes 56S.

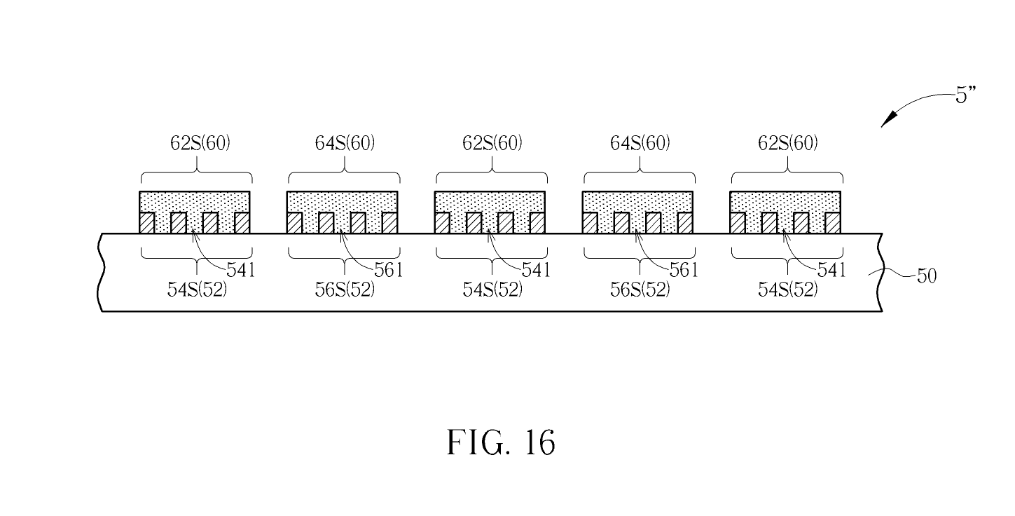

Please refer to FIG. 16. FIG. 16 is a schematic diagram illustrating a capacitive touch panel according to a second variant of the fifth embodiment of the present invention. As shown in FIG. 16, in the capacitive touch panel 5″ of the second variant embodiment, the material of the first conductive layer 52 includes opaque conductive materials, which may be metal, for example but not limited to, at least one of gold (Au), aluminum (Al), copper (Cu), silver (Ag), chromium (Cr), titanium (Ti), molybdenum (Mo), neodymium (Nd), an alloy thereof, a composite layer thereof, and the composite layer of the above-mentioned materials and alloys. However, the opaque conductive materials are not limited to the above-mentioned materials and the opaque conductive materials may also include other conductive materials. Moreover, the above-mentioned composite layers may be three-layer stacked structures, which comprise molybdenum (Mo), Al—Nd alloy (i.e., an alloy of aluminum and neodymium) and molybdenum (Mo) disposed in that order, but the present invention is not limited to this and any stacked structure with the desired conductive properties is within the scope of the present invention. The material of the second conductive layer 60 may include transparent conductive materials, inter alia, indium tin oxide (ITO), indium zinc oxide (IZO) or other kinds of transparent conductive materials—in other words, the third sensing electrodes 62S and the fourth sensing electrodes 64S are transparent electrodes. The third sensing electrodes 62S are disposed on the first sensing electrodes 54S respectively; moreover, the third sensing electrodes 62S are in contact with and electrically connected to the first sensing electrodes 54S respectively. The fourth sensing electrodes 64S are disposed on the second sensing electrodes 56S respectively, and the fourth sensing electrodes 64S are in contact with and electrically connected to the second sensing electrodes 56S respectively. In the second variant embodiment, the second conductive layer 60 is formed after the first conductive layer 52 has been formed, but not limited thereto. For example, in another variant embodiment, the first conductive layer 52 is formed after the second conductive layer 60 has been formed.

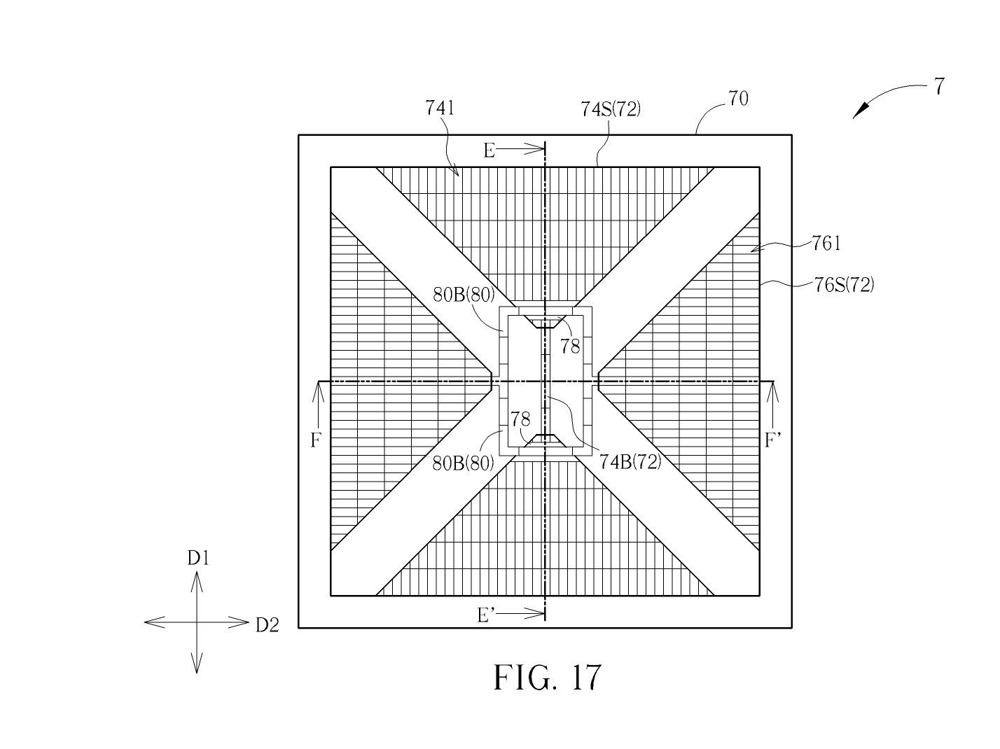

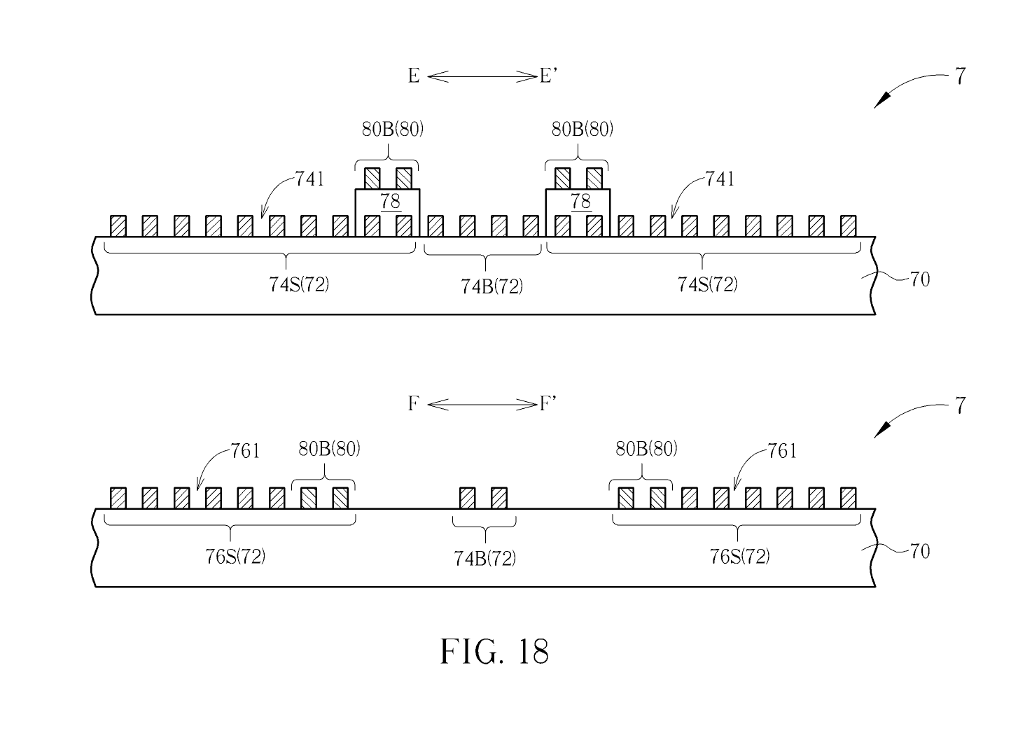

Please refer to FIGS. 17-18. FIGS. 17-18 are schematic diagrams illustrating a capacitive touch panel according to a sixth embodiment of the present invention. FIG. 17 is a schematic diagram illustrating a top view of the capacitive touch panel according to the sixth embodiment of the present invention. FIG. 18 is a cross-sectional view diagram taken along cross-sectional lines, E-E′ and F-F′, in FIG. 17. As shown in FIGS. 17-18, the capacitive touch panel 7 in this embodiment includes a substrate 70, a first conductive layer 72 disposed on the substrate 70, a second conductive layer 80 disposed on the substrate 70 and a plurality of insulation patterns 78 disposed on the substrate 70. The first conductive layer 72 includes a plurality of first sensing electrodes 74S, a plurality of first bridge electrodes 74B and a plurality of second sensing electrodes 76S. The first sensing electrodes 74S are disposed along a first direction D1. The first bridge electrodes 74B are electrically connected to two of the first sensing electrodes 74S adjacent to each other respectively. The second sensing electrodes 76S are disposed along a second direction D2. Each of the first sensing electrodes 74S includes a meshed electrode, and the meshed electrode has a plurality of first openings 741. Each of the second sensing electrodes 76S includes a meshed electrode, and the meshed electrode has a plurality of second openings 761. The second conductive layer 80 is disposed on the substrate 70. The second conductive layer 80 includes a plurality of second bridge electrodes 80B. Each of the second bridge electrodes 80B is electrically connected to two of the second sensing electrodes 76S adjacent to each other. The insulation patterns 78 are disposed on the substrate 70. Each of the insulation patterns 78 is interposed between the second bridge electrodes 80B and the first sensing electrodes 74S corresponding to the second bridge electrodes 80B so as to electrically isolate the second bridge electrodes 80B from the first sensing electrodes 74S. The first sensing electrodes 74S, the insulation patterns 78 and the second bridge electrodes 80B partially overlap in a vertical projection direction. In other words, the insulation patterns 78 and the second bridge electrodes 80B overlap the first sensing electrodes 74S, but the insulation patterns 78 and the second bridge electrodes 80B do not overlap the first bridge electrodes 74B. The material of the first conductive layer 72 includes opaque conductive materials, which may be metal, for example but not limited to, at least one of gold (Au), aluminum (Al), copper (Cu), silver (Ag), chromium (Cr), titanium (Ti), molybdenum (Mo), neodymium (Nd), an alloy thereof, a composite layer thereof, and the composite layer of the above-mentioned materials and alloys. However, the opaque conductive materials are not limited to the above-mentioned materials and the opaque conductive materials may also include other conductive materials. Moreover, the above-mentioned composite layers may be three-layer stacked structures, which comprise molybdenum (Mo), Al—Nd alloy (i.e., an alloy of aluminum and neodymium) and molybdenum (Mo) disposed in that order, but the present invention is not limited to this and any stacked structure with the desired conductive properties is within the scope of the present invention. The material of the second conductive layer 80 includes opaque conductive materials, which may be metal, for example but not limited to, at least one of gold (Au), aluminum (Al), copper (Cu), silver (Ag), chromium (Cr), titanium (Ti), molybdenum (Mo), neodymium (Nd), an alloy thereof, a composite layer thereof, and the composite layer of the above-mentioned materials and alloys. However, the opaque conductive materials are not limited to the above-mentioned materials and the opaque conductive materials may also include other conductive materials. Moreover, the above-mentioned composite layers may be three-layer stacked structures, which comprise molybdenum (Mo), Al—Nd alloy (i.e., an alloy of aluminum and neodymium) and molybdenum (Mo) disposed in that order, but the present invention is not limited to this and any stacked structure with the desired conductive properties is within the scope of the present invention. The material of the second conductive layer 80 may also include transparent conductive materials, inter alia, indium tin oxide (ITO), indium zinc oxide (IZO) or other kinds of transparent conductive materials. In this embodiment, the insulation patterns 78 is disposed on the first conductive layer 72, and the second conductive layer 80 is disposed on the insulation patterns 78, but not limited thereto. In a variant embodiment, the insulation patterns 78 may be disposed on the second conductive layer 80, and the first conductive layer 72 may be disposed on the insulation patterns 78.

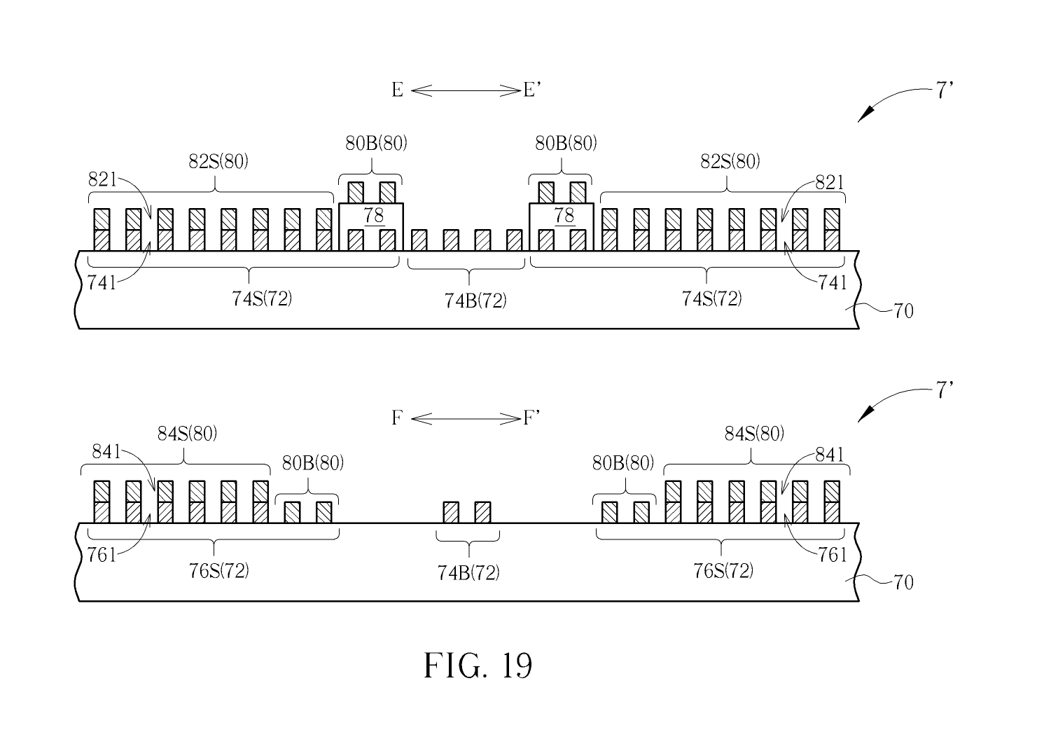

Please refer to FIG. 19, and also refer to FIG. 17. FIG. 19 is a schematic diagram illustrating a capacitive touch panel according to a first variant of the sixth embodiment of the present invention. As shown in FIG. 19, compared with the sixth embodiment, in the capacitive touch panel 7′ of the first variant embodiment, the second conductive layer 80 further includes a plurality of third sensing electrodes 82S and a plurality of fourth sensing electrodes 84S. The third sensing electrodes 82S and the fourth sensing electrodes 84S are in contact with and electrically connected to the corresponding first sensing electrodes 74S and the corresponding second sensing electrodes 76S respectively. In the first variant embodiment, the material of the second conductive layer 80 includes opaque conductive materials, which may be metal, for example but not limited to, at least one of gold (Au), aluminum (Al), copper (Cu), silver (Ag), chromium (Cr), titanium (Ti), molybdenum (Mo), neodymium (Nd), an alloy thereof, a composite layer thereof, and the composite layer of the above-mentioned materials and alloys. However, the opaque conductive materials are not limited to the above-mentioned materials and the opaque conductive materials may also include other conductive materials. Moreover, the above-mentioned composite layers may be three-layer stacked structures, which comprise molybdenum (Mo), Al—Nd alloy (i.e., an alloy of aluminum and neodymium) and molybdenum (Mo) disposed in that order, but the present invention is not limited to this and any stacked structure with the desired conductive properties is within the scope of the present invention. Each of the third sensing electrodes 82S includes a meshed electrode, and the meshed electrode has a plurality of third openings 821. The third openings 821 correspond to the first openings 741 of each of the first sensing electrodes 74S. Each of the fourth sensing electrodes 84S includes a meshed electrode, and the meshed electrode has a plurality of fourth openings 841, and the fourth openings 841 correspond to the second openings 761 of each of the second sensing electrodes 76S.

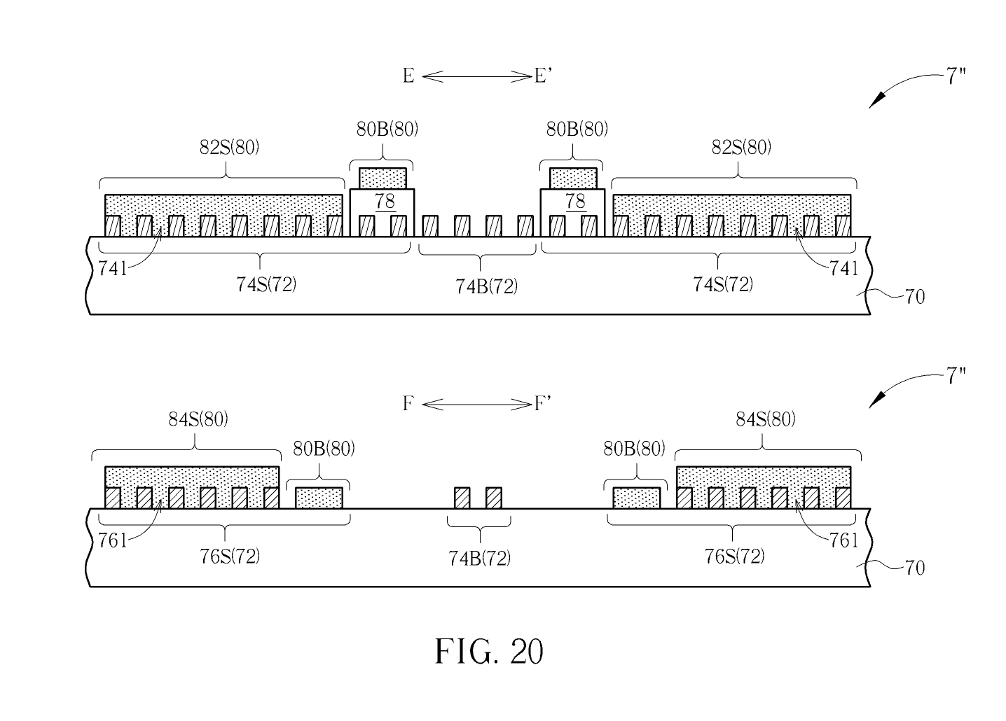

Please refer to FIG. 20, and also refer to FIG. 17. FIG. 20 is a schematic diagram illustrating a capacitive touch panel according to a second variant of the sixth embodiment of the present invention. As shown in FIG. 20, compared with the sixth embodiment, in the capacitive touch panel 7″ of the second variant embodiment, the second conductive layer 80 further includes a plurality of third sensing electrodes 82S and a plurality of fourth sensing electrodes 84S. The third sensing electrodes 82S and the fourth sensing electrodes 84S are in contact with and electrically connected to the corresponding first sensing electrodes 74S and the corresponding second sensing electrodes 76S respectively. In the second variant embodiment, the material of the second conductive layer 80 may also include transparent conductive materials, inter alia, indium tin oxide (ITO), indium zinc oxide (IZO) or other kinds of transparent conductive materials.

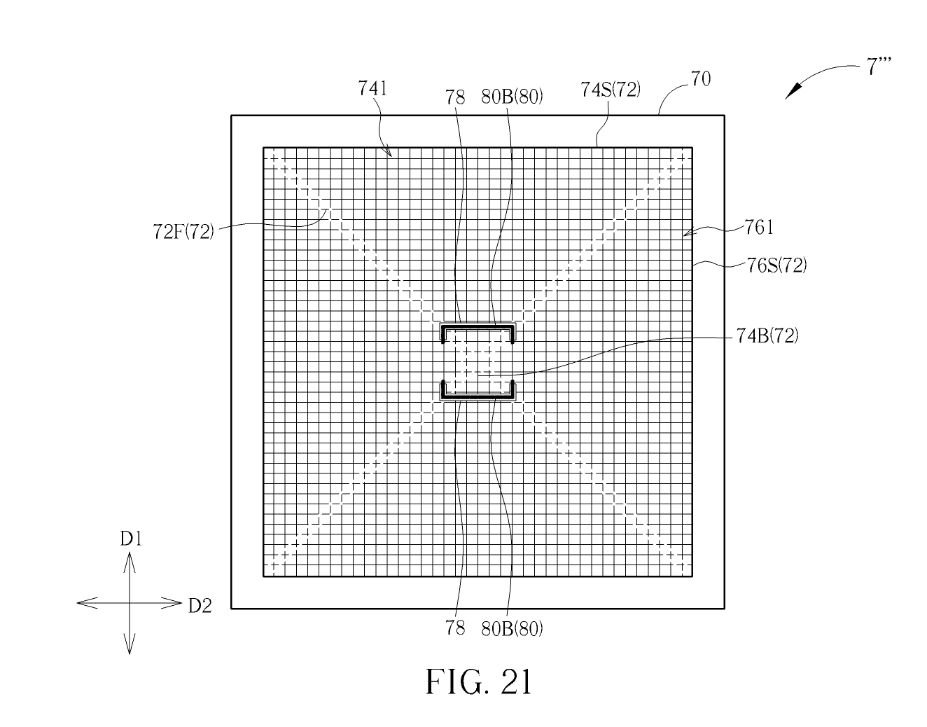

Please refer to FIG. 21. FIG. 21 is a schematic diagram illustrating a capacitive touch panel according to a third variant of the sixth embodiment of the present invention. As shown in FIG. 21, compared with the sixth embodiment, in the capacitive touch panel 7″′ of the third variant embodiment, the first conductive layer 72 further includes a dummy electrode 72F. The dummy electrode 72F is disposed between the first sensing electrodes 74S and the second sensing electrodes 76S adjacent to the first sensing electrodes 74S. The dummy electrode 72F is not electrically conducted to the first sensing electrodes 74S and the second sensing electrodes 76S. Moreover, the insulation patterns 78 are further disposed between the second bridge electrodes 80B and the dummy electrode 72F so as to electrically isolate the second bridge electrodes 80B from the dummy electrode 72F. The dummy electrode 72F is a meshed electrode. The meshed patterns of the dummy electrode 72F are similar to those of the first sensing electrodes 74S and those of the second sensing electrodes 76S. For example, the meshed patterns may be of square openings or of rectangular openings, but not limited thereto. The dummy electrode 72F disposed between the first sensing electrodes 74S and the second sensing electrodes 76S can compensate visual differences. Especially when the design of the dummy electrode 72F is applied to the display panel, viewers can hardly notice uneven brightness.

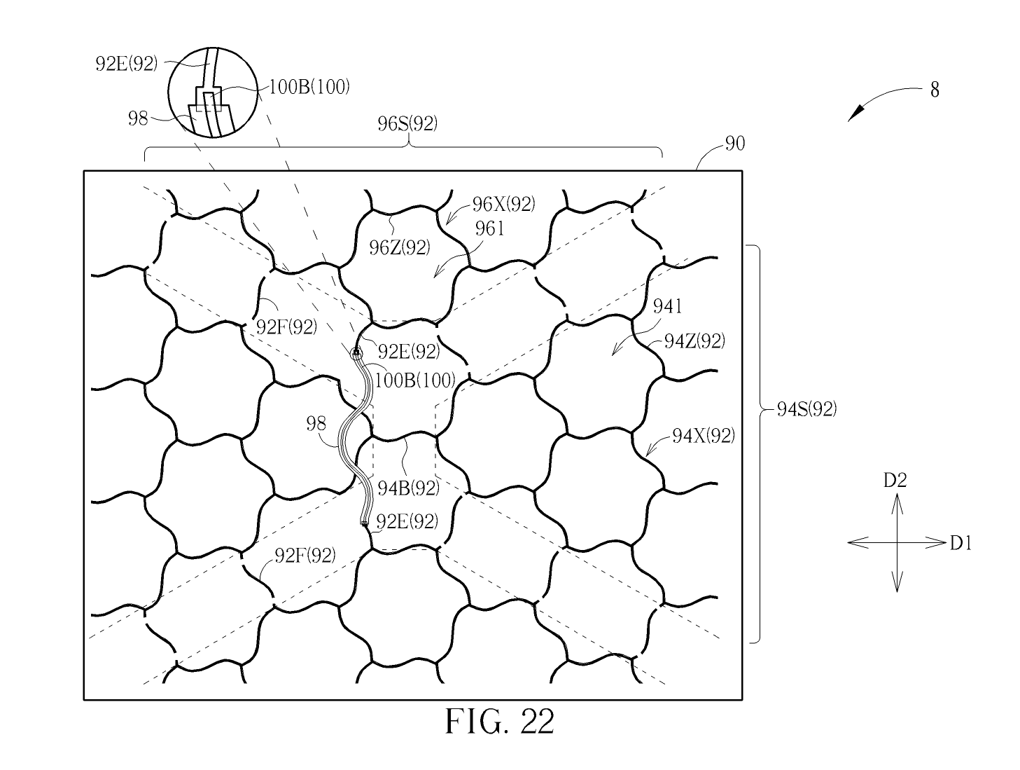

Please refer to FIG. 22. FIG. 22 is schematic diagram illustrating a capacitive touch panel according to a seventh embodiment of the present invention. As shown in FIG. 22, the capacitive touch panel 8 of the present invention includes a substrate 90, a first conductive layer 92 disposed on the substrate 90, a second conductive layer 100 disposed on the substrate 90, and a plurality of insulation patterns 98 disposed on the substrate 90. The first conductive layer 92 includes a plurality of first sensing electrodes 94S disposed along a first direction D1, a plurality of first bridge electrodes 94B respectively electrically connected to two of the first sensing electrodes 94S adjacent to each other respectively, and a plurality of second sensing electrodes 96S disposed along a second direction D2. Each of the first sensing electrodes 94S includes a meshed electrode, and the meshed electrode has a plurality of first openings 941. Each of the second sensing electrodes 96S includes a meshed electrode, and the meshed electrode has a plurality of second openings 961. The second conductive layer 100 is disposed on the substrate 90. The second conductive layer 100 includes a plurality of second bridge electrodes 100B, and each of the second bridge electrodes 100B is electrically connected to two of the second sensing electrodes 96S adjacent to each other respectively. The insulation patterns 98 are disposed on the substrate 90, wherein each of the insulation patterns 98 is interposed between the second bridge electrodes 100B and the first sensing electrodes 94S corresponding to the second bridge electrodes 100B so as to electrically isolate the second bridge electrodes 100B from the first sensing electrodes 94S. Moreover, the first sensing electrodes 94S, the insulation patterns 98 and the second bridge electrodes 100B partially overlap in a vertical projection direction. In other words, the insulation patterns 98 and the second bridge electrodes 100B overlap the first sensing electrodes 94S, but the insulation patterns 98 and the second bridge electrodes 100B do not overlap the first bridge electrodes 94B. The material of the first conductive layer 92 includes opaque conductive materials, which may be metal, for example but not limited to, at least one of gold (Au), aluminum (Al), copper (Cu), silver (Ag), chromium (Cr), titanium (Ti), molybdenum (Mo), neodymium (Nd), an alloy thereof, a composite layer thereof, and the composite layer of the above-mentioned materials and alloys. However, the opaque conductive materials are not limited to the above-mentioned materials and the opaque conductive materials may also include other conductive materials. Moreover, the above-mentioned composite layers may be three-layer stacked structures, which comprise molybdenum (Mo), Al—Nd alloy (i.e., an alloy of aluminum and neodymium) and molybdenum (Mo) disposed in that order, but the present invention is not limited to this and any stacked structure with the desired conductive properties is within the scope of the present invention. The material of the second conductive layer 100 includes opaque conductive materials, which may be metal, for example but not limited to, at least one of gold (Au), aluminum (Al), copper (Cu), silver (Ag), chromium (Cr), titanium (Ti), molybdenum (Mo), neodymium (Nd), an alloy thereof, a composite layer thereof, and the composite layer of the above-mentioned materials and alloys. However, the opaque conductive materials are not limited to the above-mentioned materials and the opaque conductive materials may also include other conductive materials. Moreover, the above-mentioned composite layers may be three-layer stacked structures, which comprise molybdenum (Mo), Al—Nd alloy (i.e., an alloy of aluminum and neodymium) and molybdenum (Mo) disposed in that order, but the present invention is not limited to this and any stacked structure with the desired conductive properties is within the scope of the present invention. In this embodiment, the insulation patterns 98 are disposed on the first conductive layer 92, and the second conductive layer 100 is disposed on the insulation patterns 98, but not limited thereto. In a variant embodiment, the insulation patterns 98 may be disposed on the second conductive layer 100, and the first conductive layer 92 may be disposed on the insulation patterns 98.

In this embodiment, each of the first sensing electrodes 94S includes a plurality of first sub sensing electrodes 94X connected to each other. Each the first sub sensing electrodes 94X includes a plurality of first zigzag wires 94Z, wherein each first zigzag wire 94Z has a width in the range of 0.1 um to 20 um. The first zigzag wires 94Z of each of the first sub sensing electrodes 94X are connected to each other and thus form a hollowed annular structure, and each of the first openings 941 is respectively defined in terms of a hollowed portion of the first sub sensing electrode 94X corresponding to the first openings 941. For example, viewing from the top view, the first zigzag wires 94Z may be respectively shaped like a sine wave, but not limited thereto. Each of the first sub sensing electrodes 94X may be, for example, a hexagon closed annular structure composed of six of the first zigzag wires 94Z connected to each other, and the first sub sensing electrodes 94X adjacent to each other may share a portion of the first zigzag wires 94Z. Besides, each of the first sensing electrodes 94S may form a diamond-shaped outline by connecting a plurality of first sub sensing electrodes 94X (as the dashed lines shown in FIG. 22). Each of the second sensing electrodes 96S includes a plurality of second sub sensing electrodes 96X connected to each other. Each of the second sub sensing electrodes 96X includes a plurality of second zigzag wires 96Z, wherein each second zigzag wire 96Z has a width in the range of 0.1 um to 20 um. The second zigzag wires 96Z of each of the second sub sensing electrodes 96X are connected to each other and thus form a hollowed annular structure, and each of the second openings 961 is respectively defined in terms of a hollowed portion of the second sub sensing electrodes 96X corresponding to the second openings 961. Similar to the first sensing electrodes 94S, viewing from the top view, the second zigzag wires 96Z may be respectively shaped like a sine wave, but not limited thereto. Each of the second sub sensing electrodes 96X may be, for example, a hexagon closed annular structure composed of six of the second zigzag wires 96Z connected to each other, and the second sub sensing electrodes 96X adjacent to each other may share a portion of the second zigzag wires 96Z. Besides, each of the second sensing electrodes 96S may form a diamond-shaped outline by connecting a plurality of second sub sensing electrodes 96X (as the dashed lines shown in FIG. 22). Furthermore, each of the first bridge electrodes 94B may be a zigzag wire respectively electrically connected to the first sub sensing electrodes 94X of two of the first sensing electrodes 94S adjacent to each other; if viewing from the top view, the first bridge electrodes 94B may be respectively shaped like a sine wave, but not limited thereto. Each of the second bridge electrodes 100B may be a zigzag wire and may respectively be but not limited thereto shaped like a sine wave. Each of the second bridge electrodes 100B is respectively electrically connected to the second sub sensing electrodes 96X of two of the second sensing electrodes 96S adjacent to each other. Moreover, the second bridge electrodes 100B, the first sub sensing electrodes 94X connected to the first bridge electrodes 94B and the insulation patterns 98 corresponding to the second bridge electrodes 100B overlap in a vertical projection direction. In other words, the second bridge electrodes 100B and the insulation patterns 98 overlap the first sub sensing electrodes 94X adjacent to the first bridge electrodes 94B, but the second bridge electrodes 100B and the insulation patterns 98 do not overlap the first bridge electrodes 94B.

In this embodiment, the first conductive layer 92 may further include a plurality of extension wires 92E. Each of the extension wires 92E and the second sub sensing electrodes 96X of the second sensing electrodes 96S corresponding to the extension wires 92E are connected. Each of the extension wires 92E may be a zigzag wire and may respectively be but not limited thereto shaped like a sine wave. The second bridge electrodes 100B may electrically connect to the second sub sensing electrodes 96X of two of the second sensing electrodes 96S adjacent to each other through two of the corresponding extension wires 92E. Each of the insulation patterns 98 may be a zigzag insulation pattern, for example but not limited thereto, shaped like a sine wave. The shape of the insulation patterns 98 substantially corresponds to that of the second bridge electrodes 100B—that is to say, both the insulation patterns 98 and the second bridge electrodes 100B are in a zigzag shape, but the width of the insulation patterns 98 is slightly wider than that of the second bridge electrodes 100B so that the second bridge electrodes 100B do not contact the first sub sensing electrodes 94X. In addition, the length of the second bridge electrodes 100B is longer than that of the insulation patterns 98, and both side of each of the second bridge electrodes 100B respectively protrudes from the edge of each of the insulation patterns 98, such that the two sides of each of the second bridge electrodes 100B may directly contact two of the extension wires 92E of the adjacent second sensing electrodes 96S. Moreover, the first conductive layer 92 may further include a dummy electrode 92F. The dummy electrode 92F is interposed between the first sensing electrodes 94S and the second sensing electrodes 96S adjacent to the first sensing electrodes 94S. The dummy electrode 92F is not electrically conducted to the first sensing electrodes 94S and the second sensing electrodes 96S. The dummy electrode 92F may be a zigzag wire and may be but not limited thereto shaped like a sine wave.

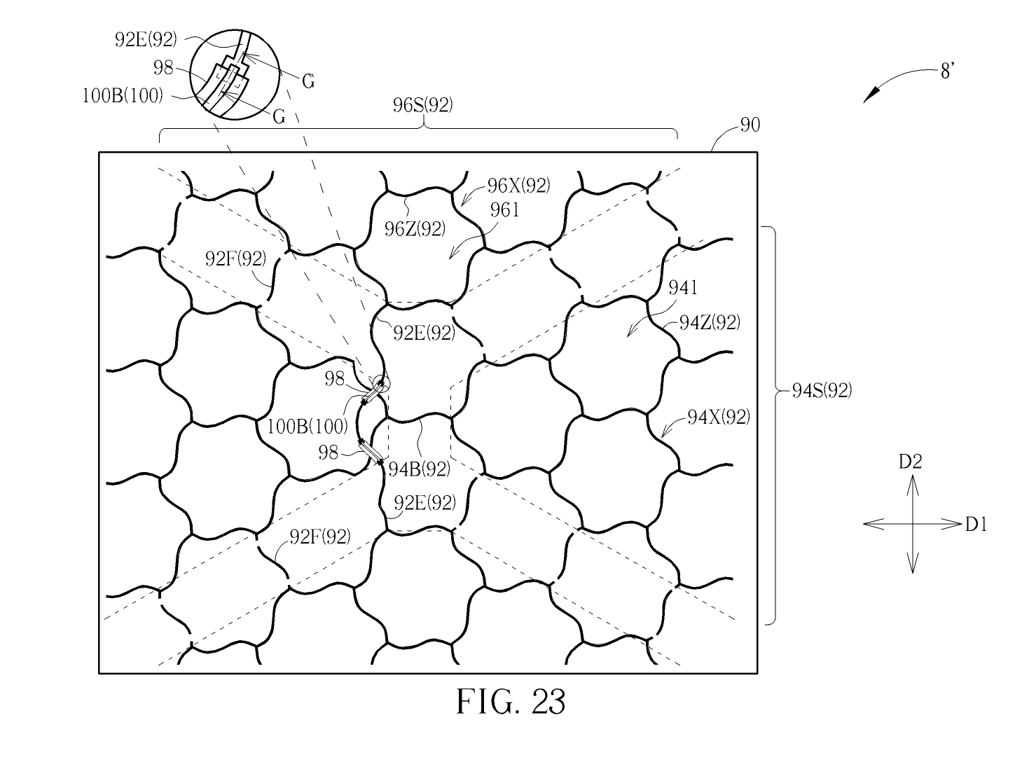

Please refer to FIG. 23. FIG. 23 is a schematic diagram illustrating a capacitive touch panel according to a variant of the seventh embodiment of the present invention. As shown in FIG. 23, compared with the seventh embodiment, in the capacitive touch panel 8′ of the variant embodiment, the shape of the insulation patterns 98 is not limited by that of the second bridge electrodes 100B. For example, the insulation patterns 98 may respectively have a shape of rectangle and are merely disposed to cover the overlap between the second bridge electrodes 100B and the first sub sensing electrodes 94X substantially. The width of the insulation patterns 98 must be wider than that of the second bridge electrodes 100B so that the second bridge electrodes 100B do not contact the first sub sensing electrodes 94X. In addition, the length of the second bridge electrodes 100B is longer than that of the insulation patterns 98, and both side of each of the second bridge electrodes 100B respectively protrudes from the edge of each of the insulation patterns 98, such that the two sides of each of the second bridge electrodes 100B may directly contact two of the extension wires 92E of the adjacent second sensing electrodes 96S. In another variant embodiment, the insulation patterns 98 may have other shapes.

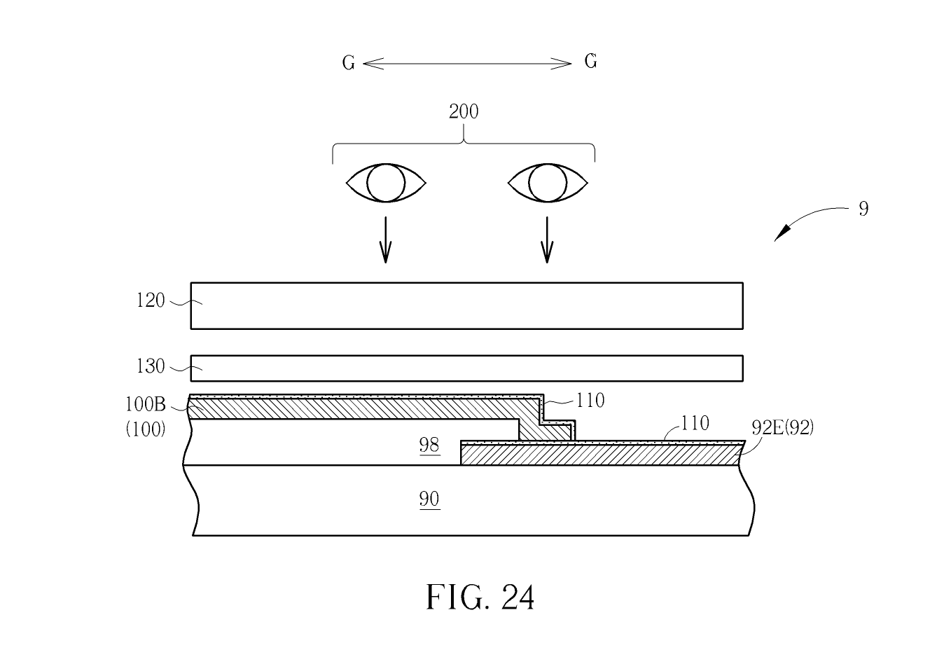

Please refer to FIG. 24. FIG. 24 is a schematic diagram illustrating a capacitive touch panel according to an eighth embodiment of the present invention, wherein FIG. 24 is a cross-sectional view diagram taken along a cross-sectional line G-G′ in FIG. 23. As shown in FIG. 24, compared with the seventh embodiment, the capacitive touch panel 9 of the eighth embodiment may further include an optical compensation pattern 110 disposed on at least one portion of the surface of the first conductive layer 92 and/or at least one portion of the surface of the second conductive layer 100. The optical compensation pattern 110 is able to reduce the visibility of the first conductive layer 92 and the second conductive layer 100, such that the viewer 200 rarely notices the first conductive layer 92 and the second conductive layer 100. The reflection from the optical compensation pattern 110 may be low and, alternatively, the optical compensation pattern 110 presents haze visual effects so as to prevent the first conductive layer 92 and the second conductive layer 100 from directly reflecting external light, thereby effectively improving visual effects. The material of the optical compensation pattern 110 may include insulation materials, such as photoresist or colored coating, or conductive materials, such as gold, aluminum, molybdenum, copper and other metal materials, an alloy thereof, metal nitride or metal oxide thereof, and materials with low reflection. For example, if the material of the first conductive layer 92 and the second conductive layer 100 is metal, then the optical compensation pattern 110 may be formed by flowing oxygen in to force oxygen to react with metal to produce metal oxide. Furthermore, the optical compensation pattern 110 may have a texture surface or present haze visual effects after additionally processes. In the present embodiment, the capacitive touch panel 9 may further include a cover 120, wherein the cover 120 is a transparent cover, such as a glass cover or a plastic cover, and the cover 120 can be adhered to the surface of the optical compensation pattern 110 with an adhesive layer 130, for example, optical adhesives. During the operation, the viewer 200 looks from the cover 120 toward the capacitive touch panel 9; therefore, the optical compensation pattern 110 is preferably interposed between the cover 120 and the first conductive layer 92/the second conductive layer 100, meaning that the viewer 200 first sees the optical compensation pattern 110 so as to make the first conductive layer 92/the second conductive layer 100 less distinct.

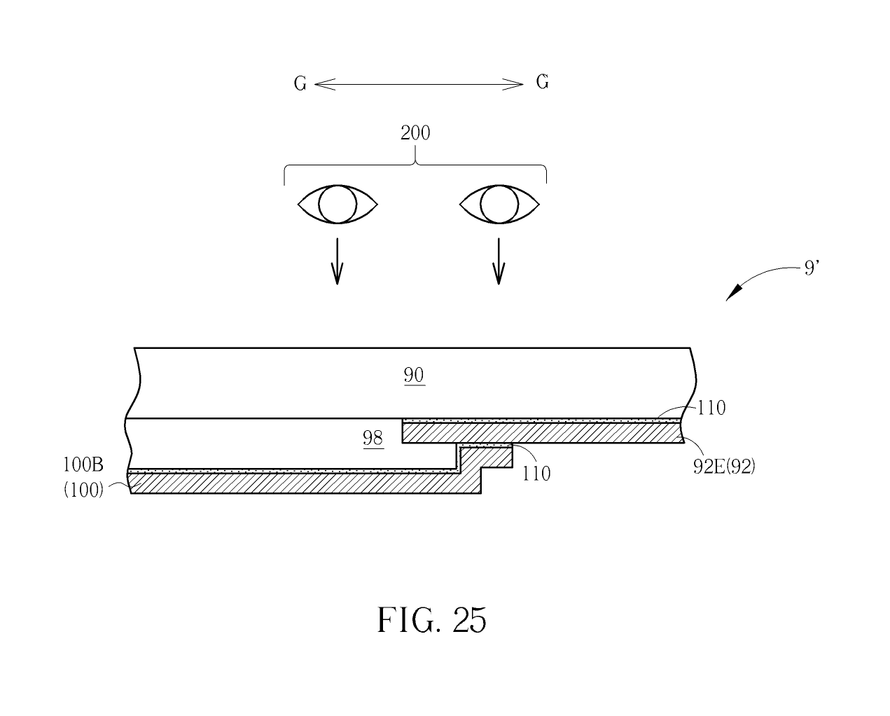

Please refer to FIG. 25. FIG. 25 is a schematic diagram illustrating a capacitive touch panel according to a first variant of the eighth embodiment of the present invention, wherein FIG. 25 is a cross-sectional view diagram taken along the cross-sectional line G-G′ in FIG. 23. As shown in FIG. 25, in the first variant embodiment, the viewer 200 looks from the substrate 90 toward the capacitive touch panel 9′—that is to say, the substrate 90 of the first variant embodiment serves as a cover, which may be, for example, the transparent cover mentioned above. Therefore, the optical compensation pattern 110 is preferably interposed between the substrate 90 and the first conductive layer 92/the second conductive layer 100 so as to make the first conductive layer 92/the second conductive layer 100 less distinct. For example, in the first variant embodiment, the optical compensation pattern 110 is formed by a two-stage process, wherein a portion of the optical compensation pattern 110 is formed before the first conductive layer 92 is formed, and the other portion of the optical compensation pattern 110 is formed before the second conductive layer 100 is formed.

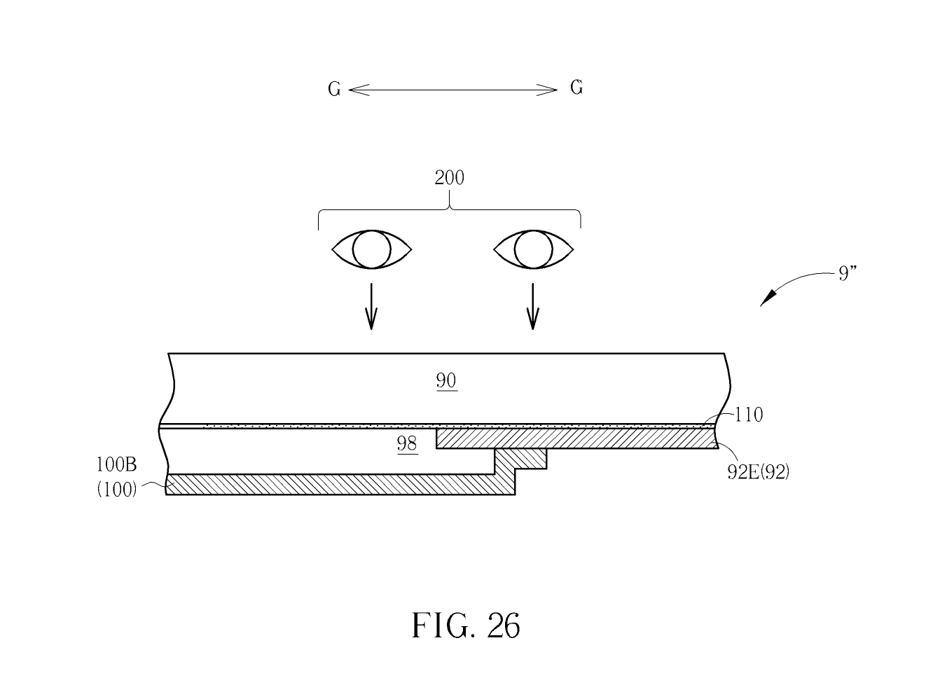

Please refer to FIG. 26. FIG. 26 is a schematic diagram illustrating a capacitive touch panel according to a second variant of the eighth embodiment of the present invention, wherein FIG. 26 is a cross-sectional view diagram taken along the cross-sectional line G-G′ in FIG. 23. As shown in FIG. 26, in the second variant embodiment, the viewer 200 also looks from the substrate 90 toward the capacitive touch panel 9″—that is to say, the substrate 90 of the second variant embodiment serves as a cover, which may be, for example, the transparent cover mentioned above. Therefore, the optical compensation pattern 110 is preferably interposed between the substrate 90 and the first conductive layer 92/the second conductive layer 100 so as to make the first conductive layer 92/the second conductive layer 100 less distinct. Unlike the first variant embodiment, in the second variant embodiment, the optical compensation pattern 110 is formed on the surface of the substrate 90 before the first conductive layer 92 and the second conductive layer 100 are formed.

The capacitive touch panels in all the embodiments of the present invention may be exemplarily embodied as self-capacitance touch panels or mutual-capacitance touch panels.

In the previous embodiments, the capacitive touch panel includes a substrate, a first conductive layer, an insulation layer and a second conductive layer, but the present invention is not limited to this. The capacitive touch panel may further include other layers, for example, at least one adhesive layer or at least one more insulation layer. Additionally, the capacitive touch panel may be integrated in a display panel to form a touch display panel. Capacitive touch panels of other embodiments in the present invention and touch display panels of the present invention will be detailed in the following description and it mainly focus on the cross-sectional view of layer structure of the capacitive touch panel and the touch display panel. As to the meshed electrodes of the capacitive touch panel and other structure features, one may refer to the aforementioned embodiment, and the similar parts are not redundantly detailed hereinafter.

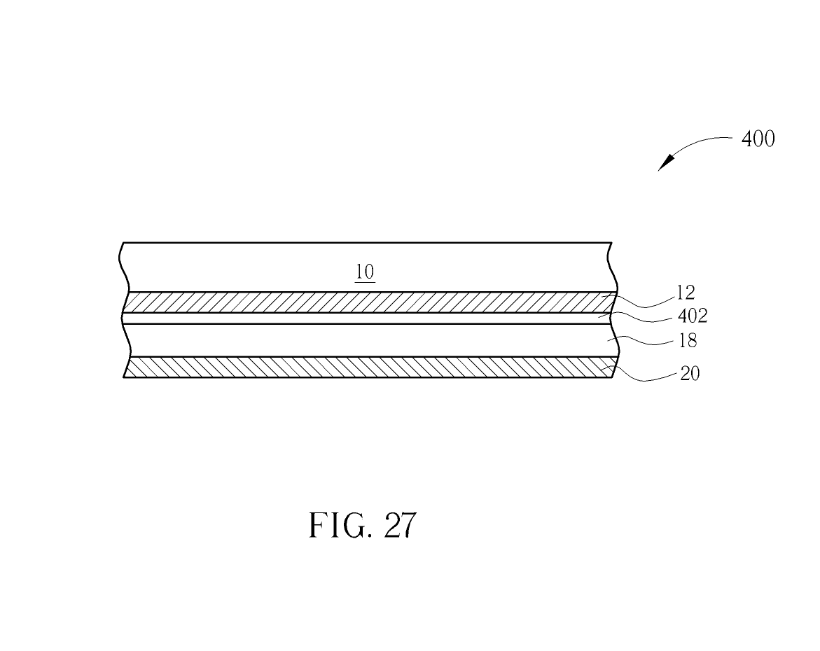

Please refer to FIG. 27. FIG. 27 is a schematic diagram illustrating a capacitive touch panel according to a ninth embodiment of the present invention. As shown in FIG. 27, the capacitive touch panel 400 of this embodiment includes a substrate 10, an adhesive layer 402, a first conductive layer 12, an insulation layer 18 and a second conductive layer 20. The first conductive layer 12 may be formed directly on the substrate 10, and the first conductive layer 12 and the insulation layer 18 may combine with the adhesive layer 402. The second conductive layer 20 is disposed on the surface of the insulation layer 18, which is opposite to the adhesive layer 402, but not limited thereto. For example, the second conductive layer 20 may be interposed between the insulation layer 18 and the adhesive layer 402. The insulation layer 18 may include, for example, a transparent insulation film and a transparent insulation substrate, such as a glass substrate, a plastic substrate, but not limited thereto. In other design, the insulation layer 18 may be made of insulation material such as organic material, inorganic material (SiO2 or SiNx) and so on.

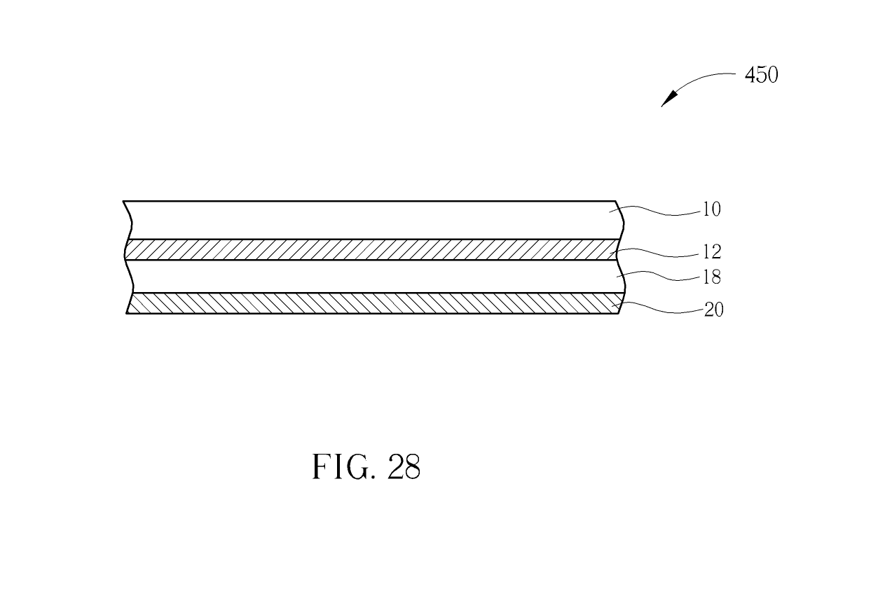

Please refer to FIG. 28. FIG. 28 is a schematic diagram illustrating a capacitive touch panel according to a tenth embodiment of the present invention. As shown in FIG. 28, the capacitive touch panel 450 of this embodiment includes a substrate 10, a first conductive layer 12, an insulation layer 18 and a second conductive layer 20. The substrate 10 is exemplarity embodied as a transparent substrate, such as a glass substrate, a plastic substrate or other kinds of substrates permeable to light and of which the transmittance higher than 85% is still within the scope of the present invention. The transparent substrate may be a transparent cover. Since the first conductive layer 12, the insulation layer 18 and the second conductive layer 20 are formed on the substrate 10 in sequence, the adhesive layer can be omitted. However, the adhesive layer can be interposed between the substrate 10 and the first conductive layer 12 or interposed between the first conductive layer 12 and the insulation layer 18.

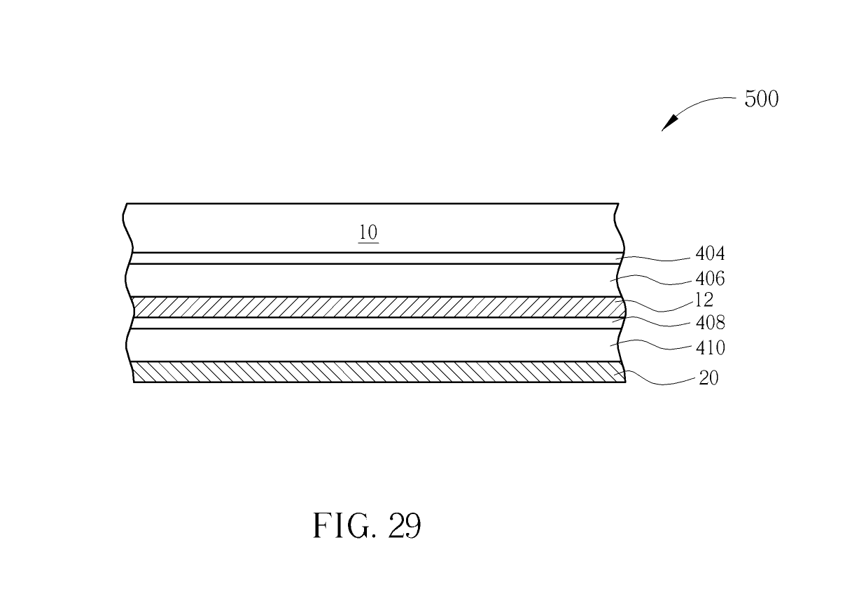

Please refer to FIG. 29. FIG. 29 is a schematic diagram illustrating a capacitive touch panel according to an eleventh embodiment of the present invention. As shown in FIG. 29, the capacitive touch panel 500 of this embodiment includes a substrate 10, a first adhesive layer 404, a first insulation layer 406, a first conductive layer 12, a second adhesive layer 408, a second insulation layer 410 and a second conductive layer 20. The first insulation layer 406 is interposed between the first conductive layer 12 and the substrate 10, and the first conductive layer 12 may be formed directly on the first insulation layer 406. The first adhesive layer 404 is interposed between the first insulation layer 406 and the substrate 10 so as to combine the first insulation layer 406 and the substrate 10. The second adhesive layer 408 is interposed between the second insulation layer 410 and the first conductive layer 12 so as to combine the second insulation layer 410 and the first conductive layer 12. The second conductive layer 20 is disposed on the surface of the second insulation layer 410, which is opposite to the second adhesive layer 408, but not limited thereto. For example, the second conductive layer 20 may be interposed between the second insulation layer 410 and the second adhesive layer 408, similarly, the first conductive layer 12 may be interposed between the first adhesive layer 404 and the first insulation layer 406. The first insulation layer 406 and the second insulation layer 410 may include, for example, a transparent insulation film and a transparent insulation substrate, such as a glass substrate, a plastic substrate, but not limited thereto. In other embodiments, a decoration layer may be selectively formed at least one side of the substrate 10. Preferably, the decoration layer may be formed to surround the substrate 10.

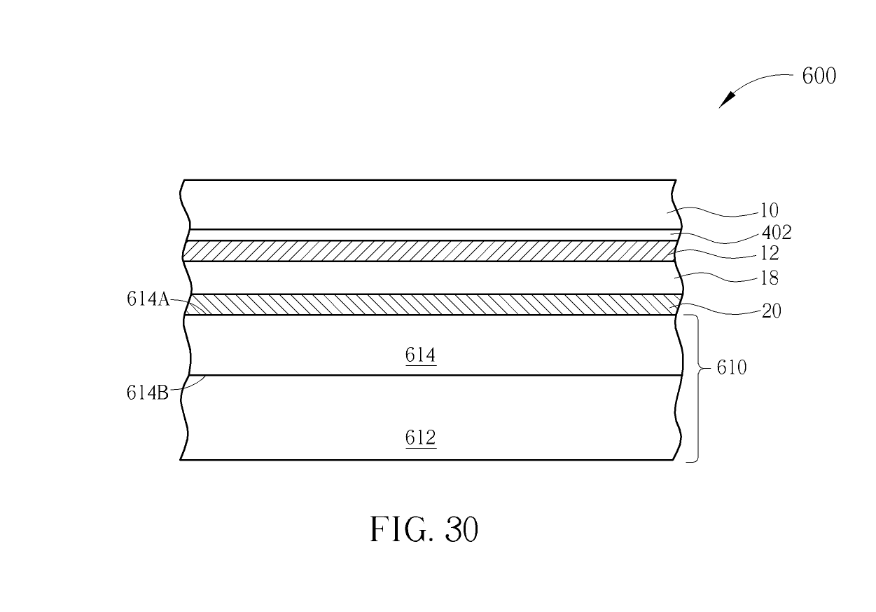

Please refer to FIG. 30. FIG. 30 is a schematic diagram illustrating a touch display panel according to a first embodiment of the present invention. As shown in FIG. 30, the touch display panel 600 of this embodiment includes a display panel 610, and the display panel 610 includes a lower substrate 612 and an upper substrate 614. The display panel 610 may include for example a liquid crystal display (LCD) panel, an organic light emitting diode (OLED) display panel, an electro-wetting display panel, an e-ink display panel or a plasma display panel, but not limited thereto. The lower substrate 612 may include for example a thin film transistor substrate, and the upper substrate 614 may include for example a color filter substrate or a cover. The touch display panel 600 further includes a second conductive layer 20, an insulation layer 18 and a first conductive layer 12, wherein the second conductive layer 20, the insulation layer 18 and the first conductive layer 12 are formed on an outer surface 614A of the upper substrate 614 in sequence. In addition, the first conductive layer 12 and the substrate 10 may combine with the adhesive layer 402. The substrate 10 may serve as a cover, which may be, for example, the transparent cover mentioned above.

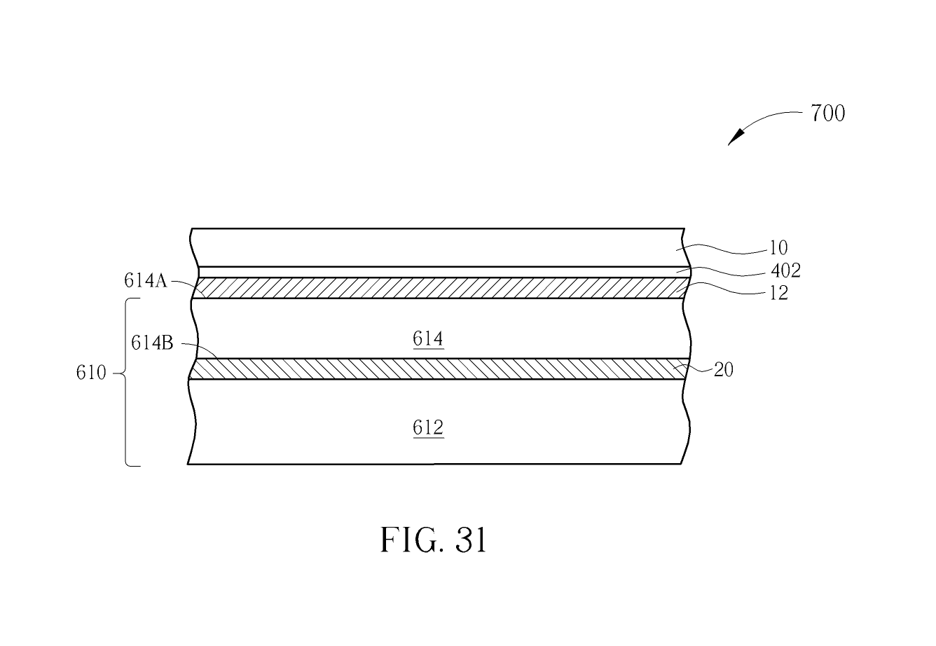

Please refer to FIG. 31. FIG. 31 is a schematic diagram illustrating a touch display panel according to a second embodiment of the present invention. As shown in FIG. 31, compared with the first embodiment, the insulation layer is omitted in the touch display panel 700 of this embodiment. In other words, the second conductive layer 20 is formed on an inner surface 614B of the upper substrate 614, and the first conductive layer 12 is formed on the outer surface 614A of the upper substrate 614. Besides, the first conductive layer 12 and the substrate 10 may combine with the adhesive layer 402. The substrate 10 may serve as a cover.

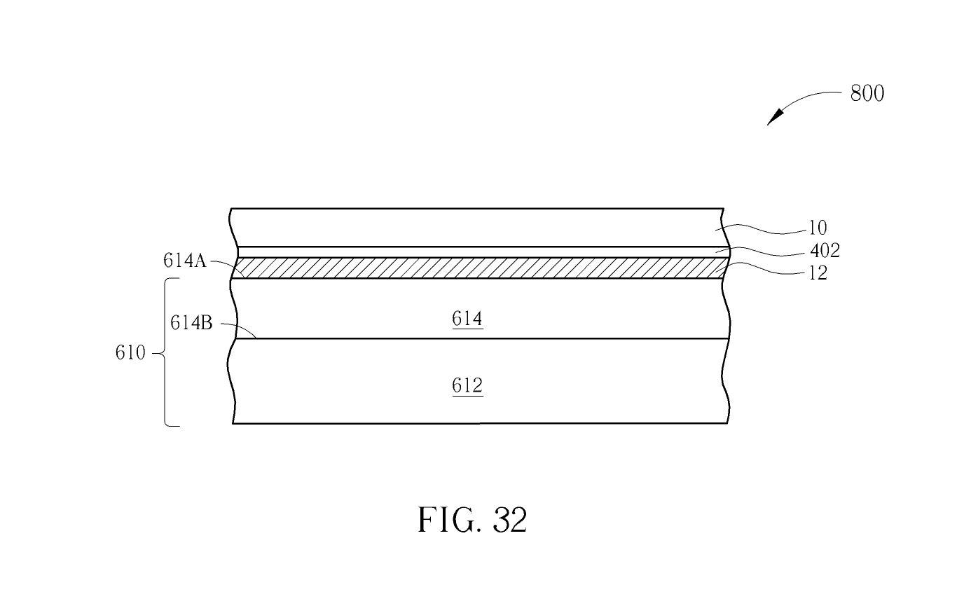

Please refer to FIG. 32. FIG. 32 is a schematic diagram illustrating a touch display panel according to a third embodiment of the present invention. As shown in FIG. 32, compared with the second embodiment, merely one conductive layer is employed in the touch display panel 800 of this embodiment. For example, the first conductive layer 12 is employed but the second conductive layer is removed. That is to say, the first conductive layer 12 is formed on the outer surface 614A of the upper substrate 614. In addition, the first conductive layer 12 and the substrate 10 may combine with the adhesive layer 402. The substrate 10 may serve as a cover. Moreover, in one embodiment, the first conductive layer and the second conductive layer may be simultaneously formed on the outer surface 614A of the upper substrate 614. The first conductive layer and the second conductive layer may be stacked as the conductive structure shown in FIG. 3 or 5, which is not redundantly detailed.

Touch display panels are not restricted to the preceding embodiments in the present invention. All of the capacitive touch panels disclosed in this embodiment of the present invention may be integrated in display panels to form touch display panels.

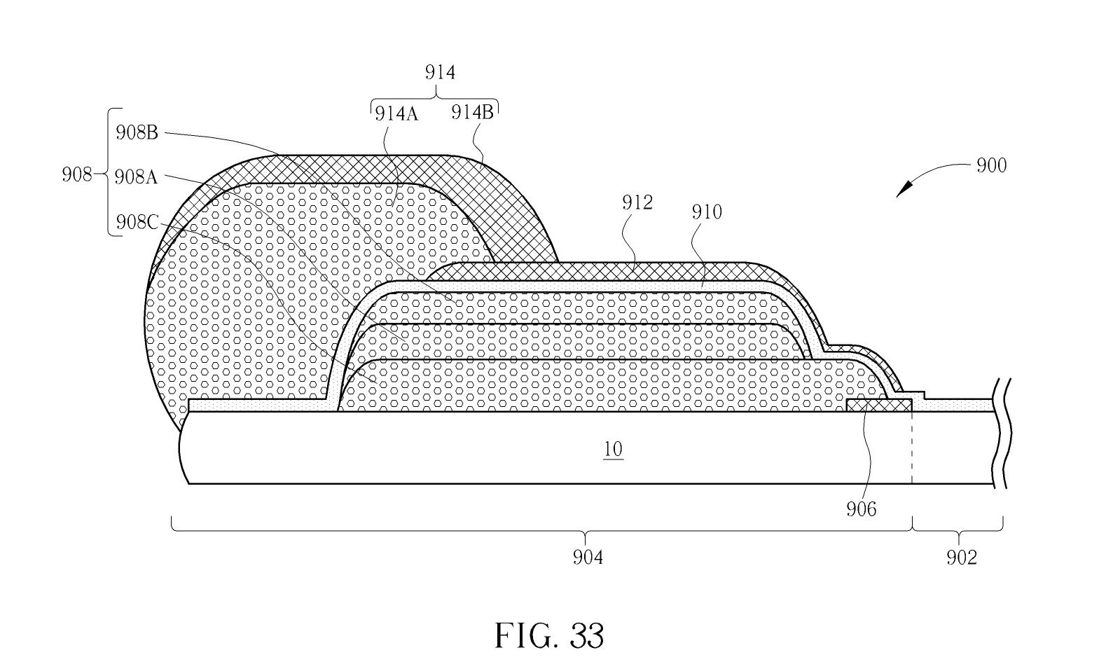

Please refer to FIG. 33. FIG. 33 is a schematic diagram illustrating the peripheral structure of a touch panel according to an embodiment of the present invention. As shown in FIG. 33, the touch panel 900 of this embodiment has a transparent region 902 and a peripheral region 904 disposed on at least one side of the transparent region 902. The above-mentioned touch elements in the aforementioned embodiments may be disposed within the transparent region 902, which is not illustrated hereinafter. The touch panel 900 includes a substrate 10, an edge decoration layer 906, a decoration layer 908, a buffer layer 910, a light-shielding layer 912 and a frame layer 914. It is worth noting that the first conductive layer/the second conductive layer (not shown) may be disposed in a portion of the peripheral structure, especially, on a portion of the buffer layer 910 and a portion of the light-shielding layer 912. The substrate 10 may include a transparent substrate or a transparent cover. The transmittance of the transparent substrate and the transparent cover, which is higher than 85%, is within the scope of the present invention. The transparent substrate may include a glass cover, a plastic cover or other kinds of covers which formed from materials of high mechanical strength to protect (for example, against scratches), cover, or decorate the corresponding devices (such as a display device). The thickness of the transparent cover may be in a range of 0.2 mm to 2 mm. The transparent cover may be in a flat shape, curved shape or the combination thereof, such as a 2.5D or 3D shaped tempered glass; however, the present invention is not limited thereto. Alternatively, an anti-smudge coating may be disposed on a side of the transparent cover for the operation of users. The edge decoration layer 906 is disposed within the peripheral region 904 adjacent to the edge of the transparent region 902, and the edge decoration layer 906 may comprise ink materials or photoresist materials. The decoration layer 908 may be a composite layer optionally and for example include a first decoration layer 908A and a second decoration layer 908B stacked on the substrate 10 from bottom to top. The pattern range of the second decoration layer 908B of this embodiment is larger than that of the first decoration layer 908A; as a result, the second decoration layer 908B covers the side of the first decoration layer 908A. Moreover, the decoration layer 908 further includes a bottom decoration layer 908C disposed beneath the first decoration layer 908A, wherein the pattern range of the bottom decoration layer 908C is larger than that of the first decoration layer 908A and the second decoration layer 908B. Besides, the bottom decoration layer 908C is disposed close to the inner side of the transparent region 902 and is much closer to the transparent region 902 than both the first decoration layer 908A and the second decoration layer 908B are. In another embodiment, the second decoration layer 908B may alternatively be removed. In this embodiment, the first decoration layer 908A, the second decoration layer 908B and the bottom decoration layer 908C are formed from ink materials or photoresist materials of the same color, but not limited thereto—for example, any two of them have the same color, while the remaining one is another color. In addition, the alternative is one single layer of photoresist for the decoration layer 908. The buffer layer 910 is disposed on the decoration layer 908 and completely covers the surface of the substrate 10 and the decoration layer 908 as well. The buffer layer 910 is preferably formed from transparent insulation materials, such as at least one of silicon oxide, silicon nitride, titanium dioxide, niobium oxide, ink materials and photoresist materials; moreover, the stacked structure of the buffer layer 910 may be a single-layered or multiple-layered structure (such as the multiple-layered structure of at least two of the aforementioned materials) according to the optical requirement. The light-shielding layer 912 may be ink materials and photoresist materials and at least partially cover the buffer layer 910 and the decoration layer 908. The buffer layer 910 is interposed between the light-shielding layer 912 and the decoration layer 908. The frame layer 914 is disposed outside of the peripheral region 904, and the frame layer 914 partially covers the light-shielding layer 912, the buffer layer 910 and the decoration layer 908. The frame layer 914 may be a composite layer and include the first frame layer 914A and the second frame layer 914B. The materials of the first frame layer 914A and the second frame layer 914B are preferably different, and alternatively, are respectively material layers of different colors. The light-shielding layer 912 and the second frame layer 914B have dark colors or colors of darker tone so as to shield the electronic components behind. The decoration layer 908 and the first frame layer 914A have light colors or colors of lighter tone so that the touch panel 900 looks brighter, but not limited thereto. What's more, the optical density of the light-shielding layer 912 is higher than that of the decoration layer 908, and preferably the optical density of the decoration layer 908 is less than 2.5. Stacked structure and number of layers of the decoration layer mentioned above are not restricted to those shown in the figures of the preceding embodiments in the present invention and may be further modified according to different design consideration.

To summarize, with the meshed sensing electrodes in the capacitive touch panels of the present invention, the impedance can be effectively reduced, thereby enhancing touch sensitivity and promoting accuracy. Moreover, the fabrication steps in the methods of fabricating the capacitive touch panels of the present invention are simplified, and therefore the production cost decreases. Additionally, the capacitive touch panels of the present invention may be integrated in display panels to form touch display panels.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A capacitive touch panel, comprising:
a substrate;
a first conductive layer, disposed on the substrate, wherein the first conductive layer comprises:
a plurality of first axis electrodes extending along a first direction, wherein each of the first axis electrodes comprises a plurality of first sensing electrodes disposed along the first direction, and a plurality of first bridge electrodes electrically connected to two of the first sensing electrodes adjacent to each other respectively, each of the first sensing electrodes comprises a meshed electrode, and the meshed electrode has a plurality of first openings; and
a plurality of second axis electrodes extending along a second direction, wherein each of the second axis electrodes comprises a plurality of second sensing electrodes, each of the second sensing electrodes comprises a meshed electrode, and the meshed electrode has a plurality of second openings; and
a second conductive layer, disposed on the substrate, wherein the second conductive layer comprises a plurality of second bridge electrodes, and each of the second bridge electrodes is at least electrically connected to two of the second sensing electrodes adjacent to each other; and
an insulation layer, disposed between the first conductive layer and the second conductive layer so as to electrically isolate the second bridge electrodes from the first bridge electrodes.

2. The capacitive touch panel according to claim 1, wherein each of the meshed electrodes has a plurality of conductive lines connected to each other and each of the plurality of conductive line has a width in a range of 0.1 micrometers (um) to 20 um.

3. The capacitive touch panel according to claim 1, wherein a material of the first conductive layer comprises an opaque conductive material, and a material of the second conductive layer comprises a transparent conductive material.

4. The capacitive touch panel according to claim 3, wherein each of the first bridge electrodes comprises a meshed electrode, and the meshed electrode has a plurality of third openings.

5. The capacitive touch panel according to claim 3, wherein the second conductive layer further comprises a plurality of third sensing electrodes, and the third sensing electrodes are in contact with and electrically connected to the first sensing electrodes respectively.

6. The capacitive touch panel according to claim 5, wherein the second conductive layer further comprises a plurality of fourth sensing electrodes, and the fourth sensing electrodes are in contact with and electrically connected to the second sensing electrodes respectively.

7. The capacitive touch panel according to claim 1, wherein a material of the first conductive layer comprises an opaque conductive material, and a material of the second conductive layer comprises an opaque conductive material.

8. The capacitive touch panel according to claim 7, wherein each of the second bridge electrodes comprises a meshed electrode, and the meshed electrode has a plurality of third openings.

9. The capacitive touch panel according to claim 7, wherein the second conductive layer further comprises:
a plurality of third sensing electrodes, wherein the third sensing electrodes are in contact with and electrically connected to the first sensing electrodes respectively, each of the third sensing electrodes comprises a meshed electrode, and the meshed electrode has a plurality of fourth openings, and the fourth openings correspond to the first openings of each of the first sensing electrodes; and
a plurality of fourth sensing electrodes, wherein the fourth sensing electrodes are in contact with and electrically connected to the second sensing electrodes respectively, each of the fourth sensing electrodes comprises a meshed electrode, and the meshed electrode has a plurality of fifth openings, and the fifth openings correspond to the second openings of each of the second sensing electrodes.

10. The capacitive touch panel according to claim 1, further comprising a protective layer covering the first conductive layer, the insulation layer and the second conductive layer.

11. The capacitive touch panel according to claim 1, wherein the first conductive layer is disposed between the substrate and the insulation layer, and the insulation layer is disposed between the first conductive layer and the second conductive layer.

12. The capacitive touch panel according to claim 1, wherein the second conductive layer is disposed between the substrate and the insulation layer, and the insulation layer is disposed between the second conductive layer and the first conductive layer.

13. The capacitive touch panel according to claim 1, further comprising a light-shielding layer and a decoration layer disposed on the substrate and located within a peripheral region, wherein an optical density of the light-shielding layer is higher than an optical density of the decoration layer.

14. A method of fabricating a capacitive touch panel, comprising:
providing a substrate;
forming a first conductive layer on the substrate, wherein the first conductive layer comprises:
a plurality of first axis electrodes extending along a first direction, wherein each of the first axis electrodes comprises a plurality of first sensing electrodes disposed along the first direction, and a plurality of first bridge electrodes electrically connected to two of the first sensing electrodes adjacent to each other respectively, each of the first sensing electrodes comprises a meshed electrode, and the meshed electrode has a plurality of first openings; and
a plurality of second axis electrodes extending along a second direction, wherein each of the second axis electrodes comprises a plurality of second sensing electrodes, each of the second sensing electrodes comprises a meshed electrode, and the meshed electrode has a plurality of second openings;
forming a second conductive layer on the substrate, wherein the second conductive layer comprises a plurality of second bridge electrodes, and each of the second bridge electrodes is at least electrically connected to two of the second sensing electrodes adjacent to each other; and
forming an insulation layer on the substrate so as to electrically isolate the second bridge electrodes from the first bridge electrodes.

15. The method of fabricating the capacitive touch panel according to claim 14, wherein each of the meshed electrodes has a plurality of conductive lines connected to each other and each of the plurality of conductive line has a width in a range of 0.1 um to 20 um.

16. The method of fabricating the capacitive touch panel according to claim 14, wherein the insulation layer is formed after the first conductive layer has been formed, and the second conductive layer is formed after the insulation layer has been formed.

17. The method of fabricating the capacitive touch panel according to claim 14, wherein the insulation layer is formed after the second conductive layer has been formed, and the first conductive layer is formed after the insulation layer has been formed.

18. The method of fabricating the capacitive touch panel according to claim 14, wherein a material of the first conductive layer comprises an opaque conductive material, and a material of the second conductive layer comprises a transparent conductive material.

19. The method of fabricating the capacitive touch panel according to claim 18, wherein each of the first bridge electrodes comprises a meshed electrode, and the meshed electrode has a plurality of third openings.

20. The method of fabricating the capacitive touch panel according to claim 19, wherein the second conductive layer further comprises a plurality of third sensing electrodes, and the third sensing electrodes are in contact with and electrically connected to the first sensing electrodes respectively.

21. The method of fabricating the capacitive touch panel according to claim 20, wherein the second conductive layer further comprises a plurality of fourth sensing electrodes, and the fourth sensing electrodes are in contact with and electrically connected to the second sensing electrodes respectively.

22. The method of fabricating the capacitive touch panel according to claim 14, wherein a material of the first conductive layer comprises an opaque conductive material, and a material of the second conductive layer comprises an opaque conductive material.

23. The method of fabricating the capacitive touch panel according to claim 22, wherein each of the second bridge electrodes comprises a meshed electrode, and the meshed electrode has a plurality of third openings.

24. The method of fabricating the capacitive touch panel according to claim 22, wherein the second conductive layer further comprises:
a plurality of third sensing electrodes, wherein the third sensing electrodes are in contact with and electrically connected to the first sensing electrodes respectively, each of the third sensing electrodes comprises a meshed electrode, and the meshed electrode has a plurality of fourth openings, and the fourth openings correspond to the first openings of each of the first sensing electrodes; and
a plurality of fourth sensing electrodes, wherein the fourth sensing electrodes are in contact with and electrically connected to the second sensing electrodes respectively, each of the fourth sensing electrodes comprises a meshed electrode, and the meshed electrode has a plurality of fifth openings, and the fifth openings correspond to the second openings of each of the second sensing electrodes.

25. The method of fabricating the capacitive touch panel according to claim 14, further comprising forming a protective layer on the substrate, wherein the protective layer covers the first conductive layer, the insulation layer and the second conductive layer.

26. A capacitive touch panel, comprising:
a substrate; and
a first conductive layer, disposed on the substrate, wherein the first conductive layer comprises:
a plurality of first sensing electrodes, wherein each of the first sensing electrodes comprises a meshed electrode, and the meshed electrode has a plurality of first openings; and
a plurality of second sensing electrodes, wherein each of the second sensing electrodes comprises a meshed electrode, and the meshed electrode has a plurality of second openings;
wherein the first sensing electrodes and the second sensing electrodes are not electrically conducted to each other.

27. The capacitive touch panel according to claim 26, wherein each of the meshed electrodes has a plurality of conductive lines connected to each other and each of the plurality of conductive line has a width in a range of 0.1 um to 20 um.

28. The capacitive touch panel according to claim 26, further comprising a second conductive layer disposed on the first conductive layer, wherein the second conductive layer comprises:
a plurality of third sensing electrodes, wherein the third sensing electrodes are disposed on the first sensing electrodes respectively, and the third sensing electrodes are in contact with and electrically connected to the first sensing electrodes respectively; and
a plurality of fourth sensing electrodes, wherein the fourth sensing electrodes are disposed on the second sensing electrodes respectively, and the fourth sensing electrodes are in contact with and electrically connected to the second sensing electrodes respectively.

29. The capacitive touch panel according to claim 28, wherein a material of the first conductive layer comprises an opaque conductive material, a material of the second conductive layer comprises an opaque conductive material, each of the third sensing electrodes comprises a meshed electrode, and the meshed electrode has a plurality of third openings, the third openings correspond to the first openings of each of the first sensing electrodes, each of the fourth sensing electrodes comprises a meshed electrode, and the meshed electrode has a plurality of fourth openings, and the fourth openings correspond to the second openings of each of the second sensing electrodes.

30. The capacitive touch panel according to claim 28, wherein a material of the first conductive layer comprises an opaque conductive material, and a material of the second conductive layer comprises a transparent conductive material.

31. The capacitive touch panel according to claim 26, wherein each of the first sensing electrodes and each of the second sensing electrodes are a driving electrode and a receiving electrode respectively.

32. The capacitive touch panel according to claim 26, further comprising a light-shielding layer and a decoration layer disposed on the substrate and located within a peripheral region, wherein an optical density of the light-shielding layer is higher than an optical density of the decoration layer.

33. A capacitive touch panel, comprising:
a substrate;
a first conductive layer, disposed on the substrate, wherein the first conductive layer comprises:
a plurality of first sensing electrodes disposed along a first direction, wherein each of the first sensing electrodes comprises a meshed electrode, and the meshed electrode has a plurality of first openings;
a plurality of first bridge electrodes electrically connected to two of the first sensing electrodes adjacent to each other respectively; and
a plurality of second sensing electrodes disposed along a second direction, wherein each of the second sensing electrodes comprises a meshed electrode, and the meshed electrode has a plurality of second openings;
a second conductive layer, disposed on the substrate, wherein the second conductive layer comprises a plurality of second bridge electrodes, and each of the second bridge electrodes is electrically connected to two of the second sensing electrodes adjacent to each other; and
a plurality of insulation patterns, disposed on the substrate, wherein each of the insulation patterns is interposed between the second bridge electrode and the first sensing electrode corresponding to the second bridge electrode so as to electrically isolate the second bridge electrodes from the first sensing electrodes, and the first sensing electrodes, the insulation patterns and the second bridge electrodes partially overlap in a vertical projection direction.

34. The capacitive touch panel according to claim 33, wherein each of the meshed electrodes has a plurality of conductive lines connected to each other and each of the plurality of conductive line has a width in a range of 0.1 um to 20 um.

35. The capacitive touch panel according to claim 33, wherein the first conductive layer further comprises a dummy electrode, the dummy electrode is disposed between the first sensing electrode and the second sensing electrodes adjacent to the first sensing electrode, and the dummy electrode is not electrically conducted to the first sensing electrodes and the second sensing electrodes.

36. The capacitive touch panel according to claim 35, wherein the insulation patterns are further disposed between the second bridge electrodes and the dummy electrode so as to electrically isolate the second bridge electrodes from the dummy electrode.

37. The capacitive touch panel according to claim 33, wherein
each of the first sensing electrodes comprises a plurality of first sub sensing electrodes connected to each other, each the first sub sensing electrodes comprises a plurality of first zigzag wires, the first zigzag wires of each of the first sub sensing electrodes are connected to each other and form a hollowed annular structure, and each of the first openings is respectively defined in terms of a hollowed portion of the first sub sensing electrode corresponding to the first openings;
each of the second sensing electrodes comprises a plurality of second sub sensing electrodes connected to each other, each the second sub sensing electrodes comprises a plurality of second zigzag wires, the second zigzag wires of each of the second sub sensing electrodes are connected to each other and form a hollowed annular structure, and each of the second openings is respectively defined in terms of a hollowed portion of the second sub sensing electrode corresponding to the second openings; and
each of the first bridge electrodes is a zigzag wire respectively electrically connected to the first sub sensing electrodes of two of the first sensing electrodes adjacent to each other.

38. The capacitive touch panel according to claim 35, wherein each of the second bridge electrodes is a zigzag wire, each of the second bridge electrodes is respectively electrically connected to the second sub sensing electrodes of two of the second sensing electrodes adjacent to each other, and the second bridge electrodes, the first sub sensing electrodes connected to the first bridge electrodes and the insulation patterns corresponding to the second bridge electrodes overlap in a vertical projection direction.

39. The capacitive touch panel according to claim 38, wherein each of the insulation patterns is a zigzag insulation pattern, and a shape of the insulation patterns substantially corresponds to a shape of the second bridge electrodes.

40. The capacitive touch panel according to claim 38, wherein the first conductive layer further comprises a plurality of extension wires, each of the extension wires and the second sub sensing electrodes of the second sensing electrodes corresponding to the extension wire are connected, each of the extension wires is a zigzag wire, and each of the second bridge electrodes is electrically connect to the second sub sensing electrodes of two of the second sensing electrodes adjacent to each other through two of the extension wires corresponding to the second bridge electrode respectively.

41. The capacitive touch panel according to claim 38, wherein the first conductive layer further comprises a dummy electrode, the dummy electrode is disposed between the first sensing electrode and the second sensing electrodes adjacent to the first sensing electrode, the dummy electrode is not electrically conducted to the first sensing electrodes and the second sensing electrodes, and the dummy electrode is a zigzag wire.

42. The capacitive touch panel according to claim 33, further comprising an optical compensation pattern disposed on at least one portion of a surface of at least one of the first conductive layer and the second conductive layer.

43. The capacitive touch panel according to claim 33, further comprising a light-shielding layer and a decoration layer disposed on the substrate and located within a peripheral region, wherein an optical density of the light-shielding layer is higher than an optical density of the decoration layer.
